(19) United States
(12) Patent Application Publication
(10) Pub. No.: US 2025/0379970 A1
(43) Pub. Date: Dec. 11, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Yang WANG, Beijing (CN); Kai ZHANG, Los Angeles, CA (US); Li ZHANG, Los Angeles, CA (US)

(21) Appl. No.: 19/300,470

(22) Filed: Aug. 14, 2025

Related U.S. Application Data
(63) Continuation of application No. PCT/CN2024/077172, filed on Feb. 12, 2024.

(30) Foreign Application Priority Data
Feb. 14, 2023 (WO) PCT/CN2023/075929

(51) Int. Cl. H04N 19/11; H04N 19/176; H04N 19/513; H04N 19/593

(52) U.S. Cl. CPC H04N 19/11; H04N 19/176; H04N 19/521; H04N 19/593

(57) ABSTRACT

Embodiments of the disclosure provide a solution for video processing. A method for video processing is proposed. The method includes: determining, for a conversion between a video unit of a video and a bitstream of the video, a search range for intra template matching prediction (IntraTMP) for a video unit; determining a prediction block of the video unit based on the search range; and performing the conversion based on the prediction block.

### CROSS REFERENCE

This application is a continuation of International Application No. PCT/CN2024/077172, filed on Feb. 12, 2024, which claims the benefit of International Application No. PCT/CN2023/075929, filed on Feb. 14, 2023. The entire contents of these applications are hereby incorporated by reference in their entireties.

### FIELDS

Embodiments of the present disclosure relates generally to video processing techniques, and more particularly, to intra template matching prediction.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, a search range for intra template matching prediction (IntraTMP) for a video unit; determining a prediction block of the video unit based on the search range; and performing the conversion based on the prediction block. In this way, it can improve coding efficiency and coding performance.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a search range for intra template matching prediction (IntraTMP) for a video unit of the video; determining a prediction block of the video unit based on the search range; and generating the bitstream based on the prediction block.

In a fifth aspect, a method for storing a bitstream of a video is proposed. The method comprises: determining a search range for intra template matching prediction (IntraTMP) for a video unit of the video; determining a prediction block of the video unit based on the search range; generating the bitstream based on the prediction block; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of encoder block diagram of VVC;

FIG. 5 illustrates 67 intra prediction modes;

FIG. 6A and FIG. 6B illustrate reference samples for wide-angular intra prediction;

FIG. 7 illustrates problem of discontinuity in case of directions beyond 45°;

FIG. 8A and FIG. 8B illustrate MMVD Search Point;

FIG. 9 illustrates an illustration for symmetrical MVD mode;

FIG. 10 illustrates an extended CU region used in BDOF;

FIG. 11 illustrates a control point based affine motion model;

FIG. 12 illustrates an affine MVF per subblock;

FIG. 13 illustrates locations of inherited affine motion predictors;

FIG. 14 illustrates control point motion vector inheritance;

FIG. 15 illustrates locations of Candidates position for constructed affine merge mode;

FIG. 16 illustrates an illustration of motion vector usage for proposed combined method;

FIG. 17 illustrates subblock MV VSB and pixel Δv(i,j) (arrow);

FIG. 18A and FIG. 18B illustrate the SbTMVP process in VVC;

FIG. 19 illustrates local illumination compensation;

FIG. 20 illustrates no subsampling for the short side;

FIG. 21 illustrates decoding side motion vector refinement;

FIG. 22 illustrates diamond regions in the search area;

FIG. 23 illustrates positions of spatial merge candidate;

FIG. 24 illustrates candidate pairs considered for redundancy check of spatial merge candidates;

FIG. 25 illustrates illustration of motion vector scaling for temporal merge candidate;

FIG. 26 illustrates candidate positions for temporal merge candidate, C0 and C1;

FIG. 27 illustrates VVC spatial neighboring blocks of the current block;

FIG. 28 illustrates illustration of virtual block in the i-th search round;

FIG. 29 illustrates examples of the GPM splits grouped by identical angles;

FIG. 30 illustrates uni-prediction MV selection for geometric partitioning mode;

FIG. 31 illustrates exemplified generation of a bending weight w₀ using geometric partitioning mode;

FIG. 32 illustrates spatial neighboring blocks used to derive the spatial merge candidates;

FIG. 33 illustrates template matching performs on a search area around initial MV;

FIG. 34 illustrates illustration of sub-blocks where OBMC applies;

FIG. 35 illustrates SBT position, type and transform type;

FIG. 36 illustrates neighbouring samples used for calculating SAD;

FIG. 37 illustrates neighbouring samples used for calculating SAD for sub-CU level motion information;

FIG. 38 illustrates the sorting process;

FIG. 39 illustrates reorder process in encoder;

FIG. 40 illustrates reorder process in decoder;

FIG. 41 illustrates an illustration of the extended reference area;

FIG. 42 illustrates IBC reference region depending on current CU position;

FIG. 43 illustrates examples of symmetry in screen content pictures;

FIG. 44A illustrates an illustration of BV adjustment for horizontal flip;

FIG. 44B illustrates an illustration of BV adjustment for vertical flip;

FIG. 45 illustrates an intra template matching search area used;

FIG. 46 illustrates an illustration of the template area;

FIG. 47 illustrates a spatial part of the convolutional filter;

FIG. 48 illustrates a reference area (with its paddings) used to derive the filter coefficients;

FIG. 49 illustrates four Sobel based gradient patterns for GLM;

FIGS. 50A-50E illustrate templates used for IntraTMP;

FIGS. 51A-51G illustrate combinations of templates used for IntraTMP;

FIG. 52 illustrates non-adjacent templates used for IntraTMP;

FIG. 53 illustrates Overlap for IntraTMP;

FIG. 54 illustrates a flowchart of a method for video processing in accordance with embodiments of the present disclosure; and

FIG. 55 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

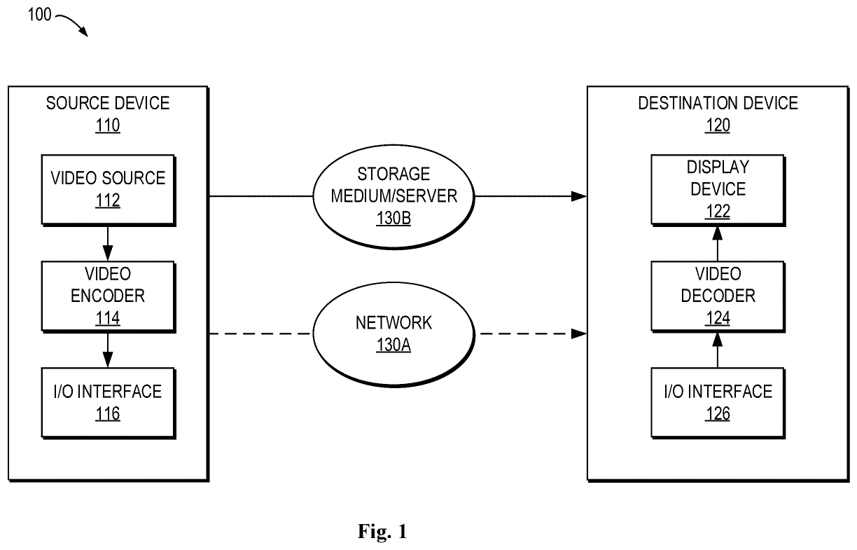

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

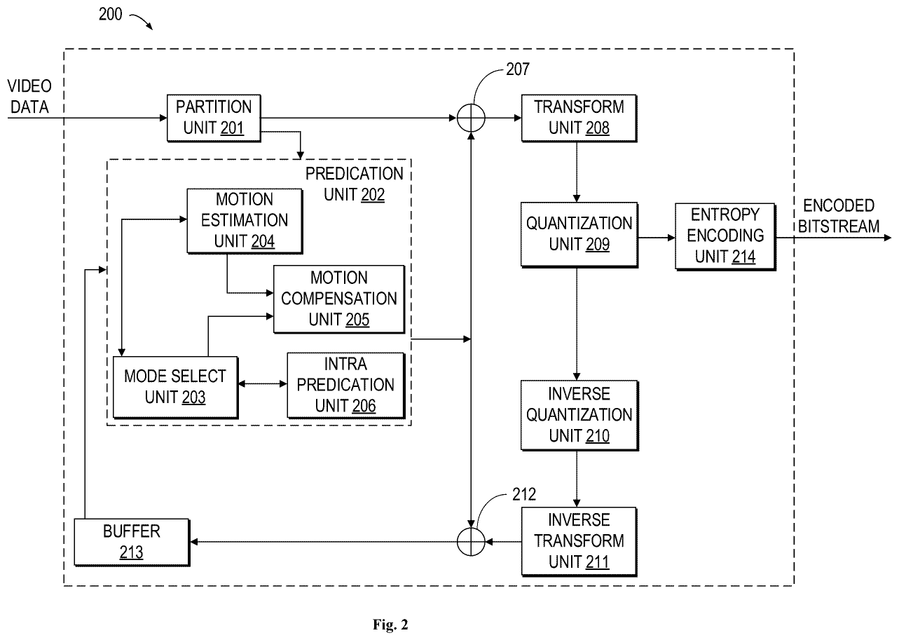

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

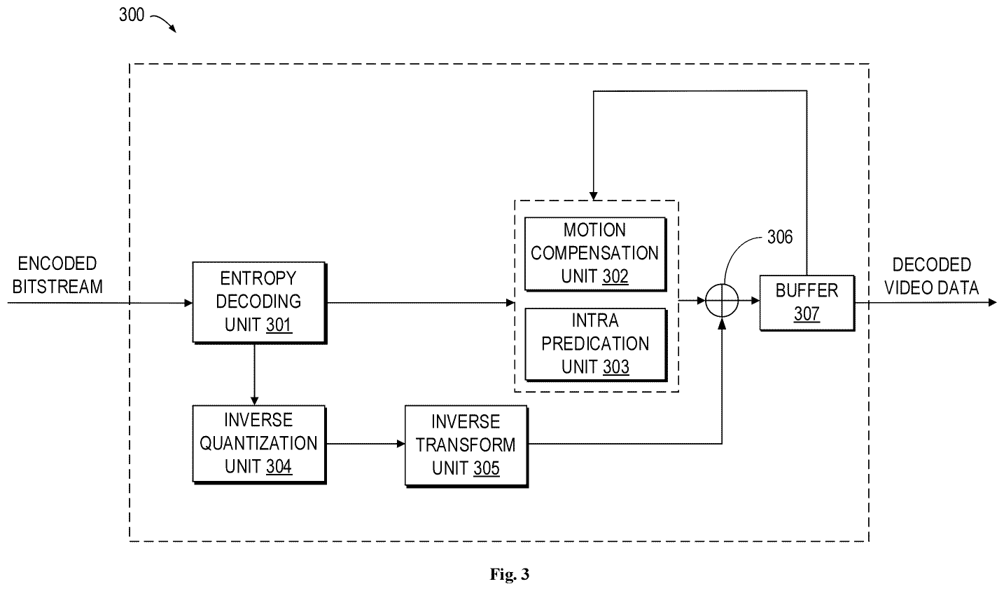

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is related to intra template matching prediction, and other coding tools in image/video coding. It may be applied to the existing video coding standard like HEVC, or Versatile Video Coding (VVC). It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. ITU-T VCEG (Q6/16) and ISO/IEC MPEG (JTC 1/SC 29/WG 5) are studying the potential need for standardization of future video coding technology with a compression capability that significantly exceeds that of the current VVC standard. Such future standardization action could either take the form of additional extension(s) of VVC or an entirely new standard. The groups are working together on this exploration activity in a joint collaboration effort known as the Joint Video Exploration Team (JVET) to evaluate compression technology designs proposed by their experts in this area. New coding features and encoding methods implemented in Enhanced Compression Model (ECM) software that are under coordinated exploration study by the Joint Video Exploration Team (JVET) of ITU-T VCEG and ISO/IEC MPEG as potential enhanced video coding technology beyond the capabilities of VVC.

### 2.1. Coding Flow of a Typical Video Codec

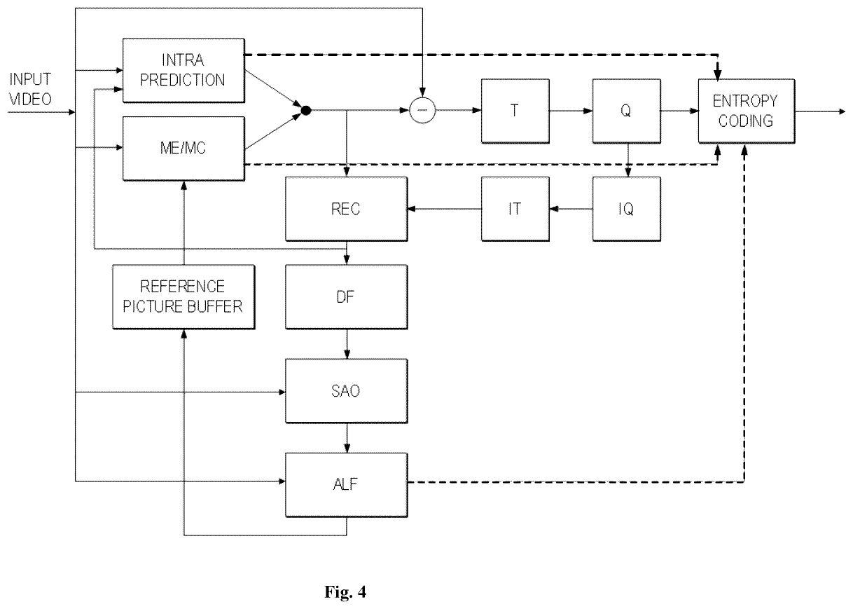

FIG. 4 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

### 2.2. Intra Mode Coding With 67 Intra Prediction Modes

To capture the arbitrary edge directions presented in natural video, the number of directional intra modes is extended from 33, as used in HEVC, to 65, as shown in FIG. 5, and the planar and DC modes remain the same. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.2.1. Wide Angle Intra Prediction

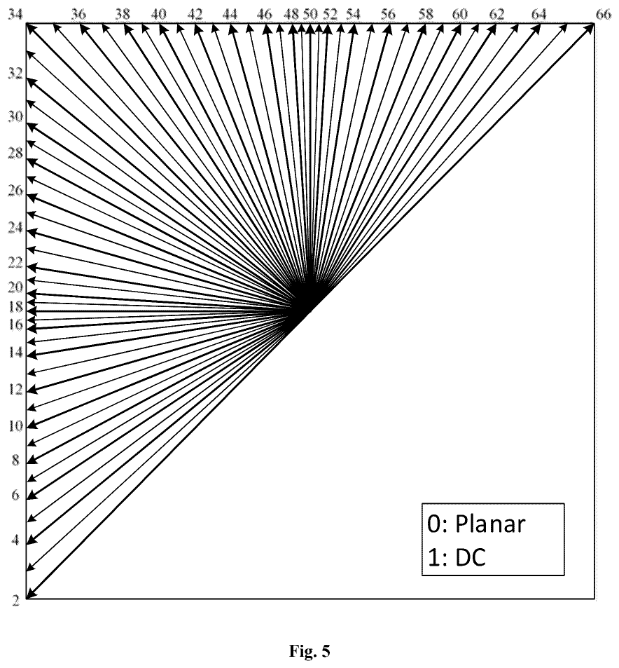

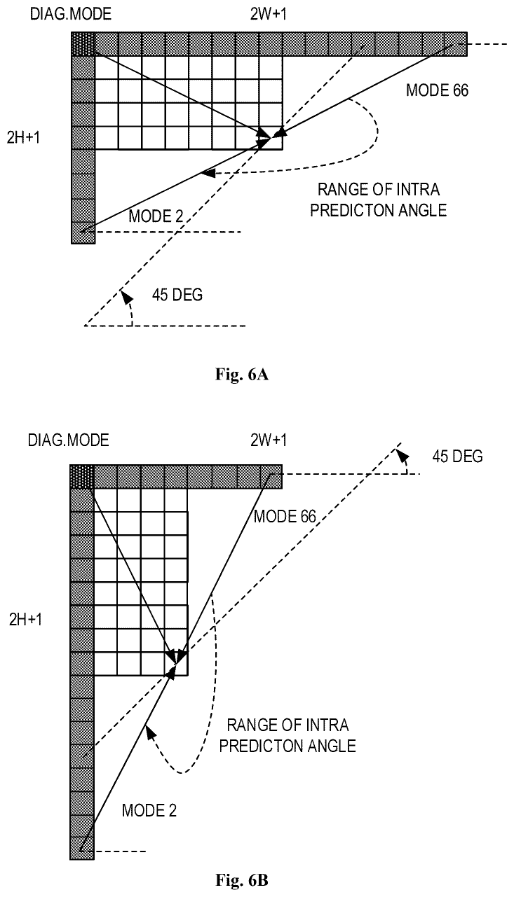

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged. To support these prediction directions, the top reference with length 2W+1, and the left reference with length 2H+1, are defined as shown in FIG. 6A and FIG. 6B.

The number of replaced modes in wide-angular direction mode depends on the aspect ratio of a block. The replaced intra prediction modes are illustrated in Table 2-1.

TABLE 2-1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, |
| | 65, 66 |

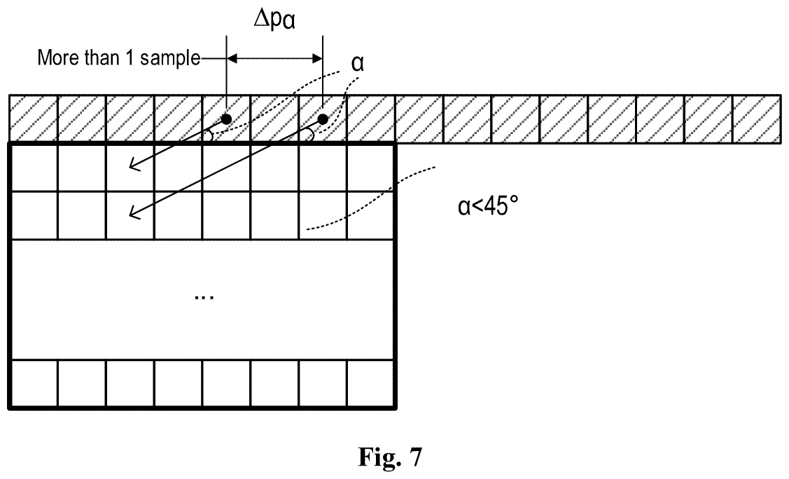

As shown in FIG. 7, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced. Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.3. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.4. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### 2.5. IBC Motion Candidates

The term ‘block’ may represent a coding tree block (CTB), a coding tree unit (CTU), a coding block (CB), a CU, a PU, a TU, a PB, a TB or a video processing unit comprising multiple samples/pixels. A block may be rectangular or non-rectangular.

For an IBC coded block, a block vector (BV) is used to indicate the displacement from the current block to a reference block, which is already reconstructed inside the current picture.

W and H are the width and height of current block (e.g., luma block).

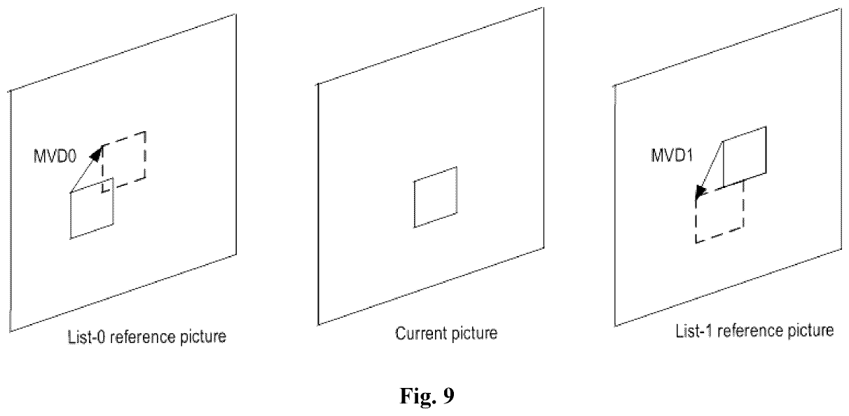

The non-adjacent spatial candidates of current coding block are adjacent spatial candidates of a virtual block in the ith search round (as shown in FIG. 9). The width and height of the virtual block for the ith search round are calculated by: newWidth=i×2×gridX+W, newHeight=i×2×gridY+H. Obviously, the virtual block is the current block if the search round i is 0.

In the following, a BV predictor also is a BV candidate. The skip mode also is the merge mode.

The BV candidates can be divided into several groups according to some criterions. Each group is called a subgroup. For example, we can take adjacent spatial and temporal BV candidates as a first subgroup and take the remaining BV candidates as a second subgroup: In another example, we can also take the first N (N≥2) BV candidates as a first subgroup, take the following M (M≥2) BV candidates as a second subgroup, and take the remaining BV candidates as a third subgroup.

### 2.6. Merge Mode With MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

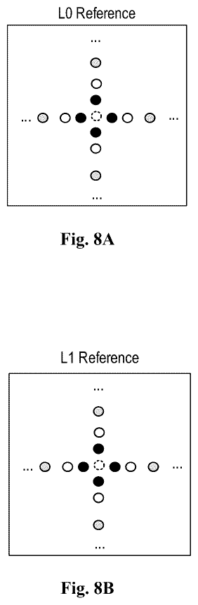

Distance index specifies motion magnitude information and indicate the pre-defined offset from the starting point. As shown in FIG. 8A and FIG. 8B, an offset is added to either horizontal component or vertical component of starting MV. The relation of distance index and pre-defined offset is specified in Table 2-2.

TABLE 2-2
The relation of distance index and pre-defined offset

| Distance IDX | 0 | 1 | 2 | 3 | 4 | 5 | 6 | 7 |
|---|---|---|---|---|---|---|---|---|
| Offset (in unit of luma sample) | ¼ | ½ | 1 | 2 | 4 | 8 | 16 | 32 |

Direction index represents the direction of the MVD relative to the starting point. The direction index can represent of the four directions as shown in Table 2-3. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2-3 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign in Table 2-3 specifies the sign of MV offset added to the list0 MV component of starting MV and the sign for the list1 MV has opposite value. Otherwise, if the difference of POC in list 1 is greater than list 0, the sign in Table 2-3 specifies the sign of MV offset added to the list1 MV component of starting MV and the sign for the list0 MV has opposite value.

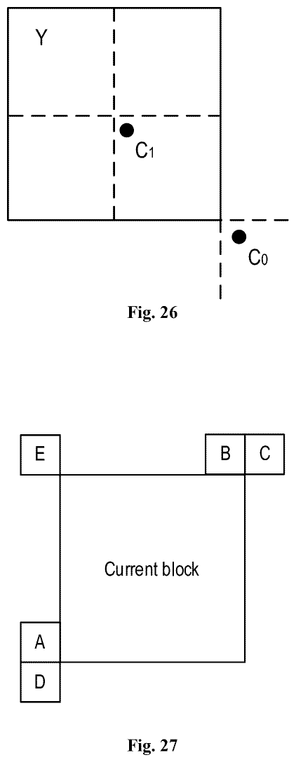

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb, described in FIG. 26. If the POC difference of L1 is greater than L0, the MVD for list 0 is scaled in the same way. If the starting MV is uni-predicted, the MVD is added to the available MV.

TABLE 2-3
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.7. Symmetric MVD Coding

In VVC, besides the normal unidirectional prediction and bi-directional prediction mode MVD signalling, symmetric MVD mode for bi-predictional MVD signalling is applied. In the symmetric MVD mode, motion information including reference picture indices of both list-0 and list-1 and MVD of list-1 are not signaled but derived.

The decoding process of the symmetric MVD mode is as follows:
1. At slice level, variables BiDirPredFlag, RefIdxSymL0 and RefIdxSymL1 are derived as follows:
   If mvd_11_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2. At CU level, a symmetrical mode flag indicating whether symmetrical mode is used or not is explicitly signaled if the CU is bi-prediction coded and BiDirPredFlag is equal to 1.

When the symmetrical mode flag is true, only mvp_10_flag, mvp_11_flag and MVD0 are explicitly signaled. The reference indices for list-0 and list-1 are set equal to the pair of reference pictures, respectively. MVD1 is set equal to (−MVD0). The final motion vectors are shown in below formula.

$$\{ \begin{matrix}( {mvx}_{0} , {mvy}_{0} ) = ( {mvpx}_{0} + {mvdx}_{0} , {mvpy}_{0} + {mvdy}_{0} ) \\ ( {mvx}_{1} , {mvy}_{1} ) = ( {mvpx}_{1} - {mvdx}_{0} , {mvpy}_{1} - {mvdy}_{0} )\end{matrix} \qquad ( 2 - 1 )$$

FIG. 9 illustrates an illustration for symmetrical MVD mode.

In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.

### 2.8. Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the SbTMVP merge mode.
CU has more than 64 luma samples.
Both CU height and CU width are larger than or equal to 8 luma samples.
BCW weight index indicates equal weight.
WP is not enabled for the current CU.
CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0,1, of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \qquad ( 2 - 2 )$$

$$\frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) )$$

where I^{(k)}(i, j) are the sample value at coordinate (i, j) of the prediction signal in list k, k=0,1, and shift1 is calculated based on the luma bit depth, bitDepth, as shift1=max (6, bitDepth-6).

Then, the auto-and cross-correlation of the gradients, S₁, S₂, S₃, S₅ and S₆, are calculated as

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) ) \qquad ( 2 - 3 )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , j ) ∈ Ω} θ ( i , j ) \cdot Sign ( {ψ}_{y} ( i , j ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \qquad ( 2 - 4 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a}$$

$$θ ( i , j ) = ( {I}^{( 1 )} ( i , j ) ≫ {n}_{b} ) - ( {I}^{( 0 )} ( i , j ) ≫ {n}_{b} )$$

where Ω is a 6×6 window around the 4×4 subblock, and the values of nₐ and n_{b} are set equal to min(1, bitDepth−11) and min(4, bitDepth−8), respectively.

The motion refinement (vₓ, v_{y}) is then derived using the cross-and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{α}} ) ≫ ⌊ {log}_{2} {S}_{1} ⌋ ) ) : 0 \qquad ( 2 - 5 )$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{α}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0$$

where

$${S}_{2 , m} = {S}_{2} ≫ {n}_{{S}_{2}} , {S}_{2 , s} = {S}_{2} \& ( {2}^{{n}_{{S}_{2}}} - 1 ) , {th}_{BIO}^{′} = {2}^{max ( 5 , BD - 7 )} .$$

└·┘ is the floor function, and nₛ_{₂}=12. Based on the motion refinement and the gradients, the following adjustment is calculated for each sample in the 4×4 subblock:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 ) . \qquad ( 2 - 6 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) ≫ shift . \qquad ( 2 - 6 )$$

These values are selected such that the multipliers in the BDOF process do not exceed 15-bit, and the maximum bit-width of the intermediate parameters in the BDOF process is kept within 32-bit.

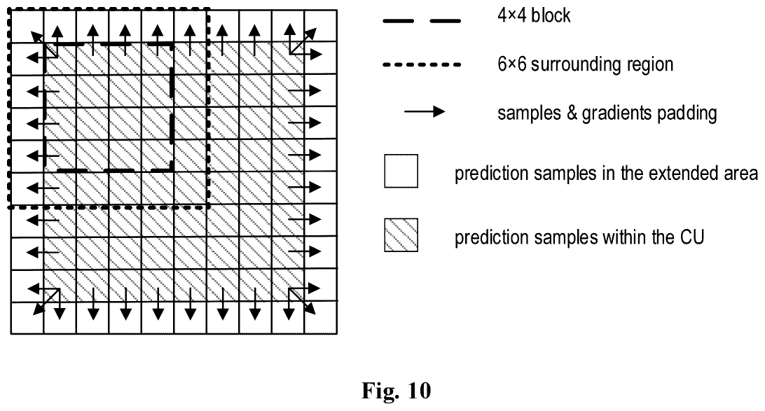

In order to derive the gradient values, some prediction samples I^{(k)}(i, j) in list k (k=0,1) outside of the current CU boundaries need to be generated. As depicted in FIG. 10, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e. repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_lx_flag is 1 for either of the two reference pictures, then BDOF is also disabled. When a CU is coded with symmetric MVD mode or CIIP mode, BDOF is also disabled.

### 2.9. Combined Inter and Intra Prediction (CIIP)

### 2.10. Affine Motion Compensated Prediction

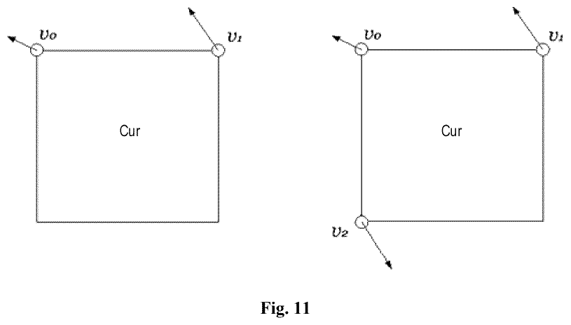

In HEVC, only translation motion model is applied for motion compensation prediction (MCP). While in the real world, there are many kinds of motion, e.g., zoom in/out, rotation, perspective motions and the other irregular motions. In VVC, a block-based affine transform motion compensation prediction is applied. FIG. 11 illustrates control point based affine motion model for a 4-parameter affine model (a) and for 6-parameter affine model (b). As shown in FIG. 11, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} . \qquad ( 2 - 8 )$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} . \qquad ( 2 - 9 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

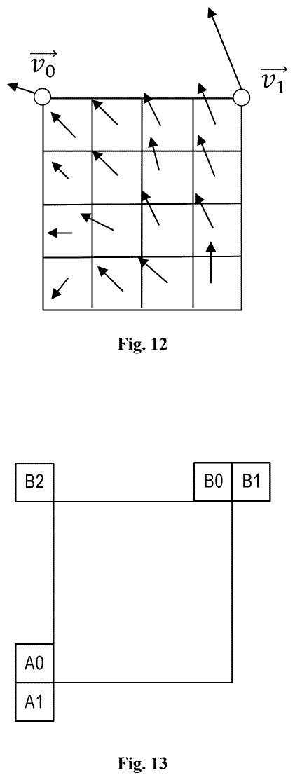

In order to simplify the motion compensation prediction, block based affine transform prediction is applied. To derive motion vector of each 4×4 luma subblock, the motion vector of the center sample of each subblock, as shown in FIG. 12, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the four corresponding 4×4 luma subblocks.

As done for translational motion inter prediction, there are also two affine motion inter prediction modes: affine merge mode and affine AMVP mode.

### 2.10.1. Affine Merge Prediction

AF_MERGE mode can be applied for CUs with both width and height larger than or equal to 8. In this mode the CPMVs of the current CU is generated based on the motion information of the spatial neighbouring CUs. There can be up to five CPMVP candidates and an index is signalled to indicate the one to be used for the current CU. The following three types of CPVM candidate are used to form the affine merge candidate list:
Inherited affine merge candidates that extrapolated from the CPMVs of the neighbour CUs,
Constructed affine merge candidates CPMVPs that are derived using the translational MVs of the neighbour CUs,
Zero MVs.

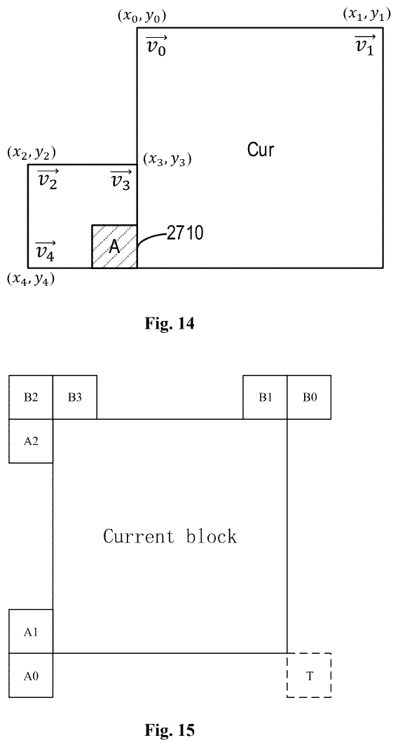

In VVC, there are maximum two inherited affine candidates, which are derived from affine motion model of the neighbouring blocks, one from left neighbouring CUs and one from above neighbouring CUs. The candidate blocks are shown in FIG. 13. For the left predictor, the scan order is A0->A1, and for the above predictor, the scan order is B0->B1->B2. Only the first inherited candidate from each side is selected. No pruning check is performed between two inherited candidates. When a neighbouring affine CU is identified, its control point motion vectors are used to derive the CPMVP candidate in the affine merge list of the current CU. As shown in FIG. 14, if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

Constructed affine candidate means the candidate is constructed by combining the neighbour translational motion information of each control point. The motion information for the control points is derived from the specified spatial neighbours and temporal neighbour shown in FIG. 15. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. For TMVP is used as CPMV₄ if it's available.

After MVs of four control points are attained, affine merge candidates are constructed based on that motion information. The following combinations of control point MVs are used to construct in order: {CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### 2.10.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs,
Constructed affine AMVP candidates CPMVPs that are derived using the translational MVs of the neighbour CUs,
Translational MVs from neighbouring CUs,
Zero MVs.

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

Constructed AMVP candidate is derived from the specified spatial neighbours shown in FIG. 15. The same checking order is used as done in affine merge candidate construction. In addition, reference picture index of the neighbouring block is also checked. The first block in the checking order that is inter coded and has the same reference picture as in current CUs is used. There is only one When the current CU is coded with 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

If affine AMVP list candidates is still less than 2 after inherited affine AMVP candidates and Constructed AMVP candidate are checked, mv₀, mv₁, and mv₂ will be added, in order, as the translational MVs to predict all control point MVs of the current CU, when available. Finally, zero MVs are used to fill the affine AMVP list if it is still not full.

### 2.10.3. Affine Motion Information Storage

In VVC, the CPMVs of affine CUs are stored in a separate buffer. The stored CPMVs are only used to generate the inherited CPMVPs in affine merge mode and affine AMVP mode for the lately coded CUs. The subblock MVs derived from CPMVs are used for motion compensation, MV derivation of merge/AMVP list of translational MVs and de-blocking.

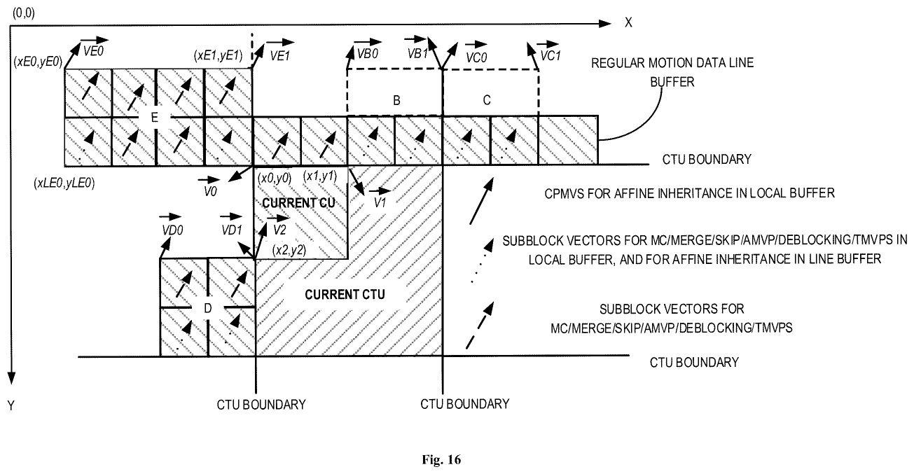

To avoid the picture line buffer for the additional CPMVs, affine motion data inheritance from the CUs from above CTU is treated differently to the inheritance from the normal neighbouring CUs. If the candidate CU for affine motion data inheritance is in the above CTU line, the bottom-left and bottom-right subblock MVs in the line buffer instead of the CPMVs are used for the affine MVP derivation. In this way, the CPMVs are only stored in local buffer. If the candidate CU is 6-parameter affine coded, the affine model is degraded to 4-parameter model. As shown in FIG. 16, along the top CTU boundary, the bottom-left and bottom right subblock motion vectors of a CU are used for affine inheritance of the CUs in bottom CTUs.

### 2.10.4. Prediction Refinement With Optical Flow for Affine Mode

Subblock based affine motion compensation can save memory access bandwidth and reduce computation complexity compared to pixel-based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps:

Step 1) The subblock-based affine motion compensation is performed to generate subblock prediction I(i,j).

Step 2) The spatial gradients gₓ(i, j) and g_{y}(i, j) of the subblock prediction are calculated at each sample location using a 3-tap filter [−1, 0, 1]. The gradient calculation is exactly the same as gradient calculation in BDOF.

$${g}_{x} ( i , j ) = ( I ( i + 1 , j ) ≫ shift1 ) - ( I ( i - 1 , j ) ≫ shift1 ) \qquad ( 2 - 10 )$$

$${g}_{y} ( i , j ) = ( I ( i , j + 1 ) ≫ shift1 ) - ( I ( i , j - 1 ) ≫ shift1 ) \qquad ( 2 - 11 )$$

shift1 is used to control the gradient's precision. The subblock (i.e. 4×4) prediction is extended by one sample on each side for the gradient calculation. To avoid additional memory bandwidth and additional interpolation computation, those extended samples on the extended borders are copied from the nearest integer pixel position in the reference picture.

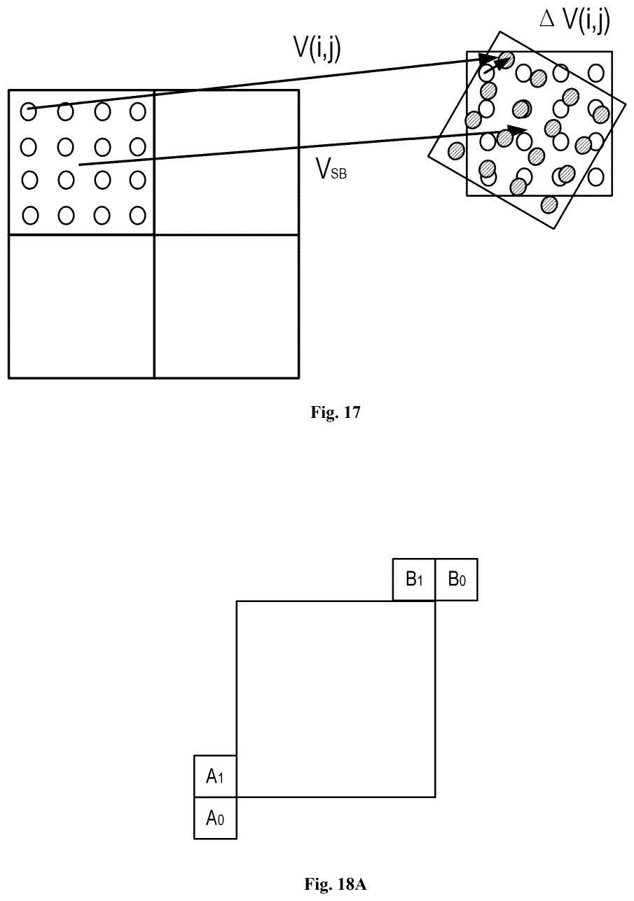

Step 3) The luma prediction refinement is calculated by the following optical flow equation.

$$Δ I ( i , j ) = {g}_{x} ( i , j ) * Δ {v}_{x} ( i , j ) + {g}_{y} ( i , j ) * Δ {v}_{y} ( i , j ) \qquad ( 2 - 12 )$$

where the Δv(i, j) is the difference between sample MV computed for sample location (i, j), denoted by v(i,j), and the subblock MV of the subblock to which sample (i, j) belongs, as shown in FIG. 17. The Δv(i, j) is quantized in the unit of 1/32 luam sample precision.

Since the affine model parameters and the sample location relative to the subblock center are not changed from subblock to subblock, Δv(i, j) can be calculated for the first subblock, and reused for other subblocks in the same CU. Let dx(i, j) and dy(i, j) be the horizontal and vertical offset from the sample location (i, j) to the center of the subblock (x_{SB}, y_{SB}), Δv(x, y) can be derived by the following equation,

$$\{ \begin{matrix}dx ( i , j ) = i - {x}_{SB} \\ dy ( i , j ) = j - {y}_{SB}\end{matrix} \qquad ( 2 - 13 )$$

$$\{ \begin{matrix}Δ {v}_{x} ( i , j ) = C * dx ( i , j ) + D * dy ( i , j ) \\ Δ {v}_{y} ( i , j ) = E * dx ( i , j ) + F * dy ( i , j )\end{matrix} \qquad ( 2 - 14 )$$

In order to keep accuracy, the enter of the subblock (x_{SB}, y_{SB}) is calculated as ((W_{SB}−1)/2, (H_{SB}−1)/2), where W_{SB} and H_{SB} are the subblock width and height, respectively.

For 4-parameter affine model,

$$\{ \begin{matrix}C = F = \frac{{v}_{1 x} - {v}_{0 x}}{w} \\ E = - D = \frac{{v}_{1 y} - {v}_{0 y}}{w}\end{matrix} . \qquad ( 2 - 15 )$$

For 6-parameter affine model,

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} . \qquad ( 2 - 16 )$$

where (v₀ₓ, v_{0y}), (v₁ₓ, v_{1y}), (v₂ₓ, v_{2y}) are the top-left, top-right and bottom-left control point motion vectors, w and h are the width and height of the CU.

Step 4) Finally, the luma prediction refinement ΔI(i, j) is added to the subblock prediction I(i, j). The final prediction I′is generated as the following equation.

$${I}^{′} ( i , j ) = I ( i , j ) + Δ I ( i , j ) . \qquad ( 2 - 17 )$$

PROF is not be applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.

A fast encoding method is applied to reduce the encoding complexity of affine motion estimation with PROF. PROF is not applied at affine motion estimation stage in following two situations: a) if this CU is not the root block and its parent block does not select the affine mode as its best mode, PROF is not applied since the possibility for current CU to select the affine mode as best mode is low; b) if the magnitude of four affine parameters (C, D, E, F) are all smaller than a predefined threshold and the current picture is not a low delay picture, PROF is not applied because the improvement introduced by PROF is small for this case. In this way, the affine motion estimation with PROF can be accelerated.

### 2.11. Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTVMP. SbTMVP differs from TMVP in the following two main aspects:
TMVP predicts motion at CU level, but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

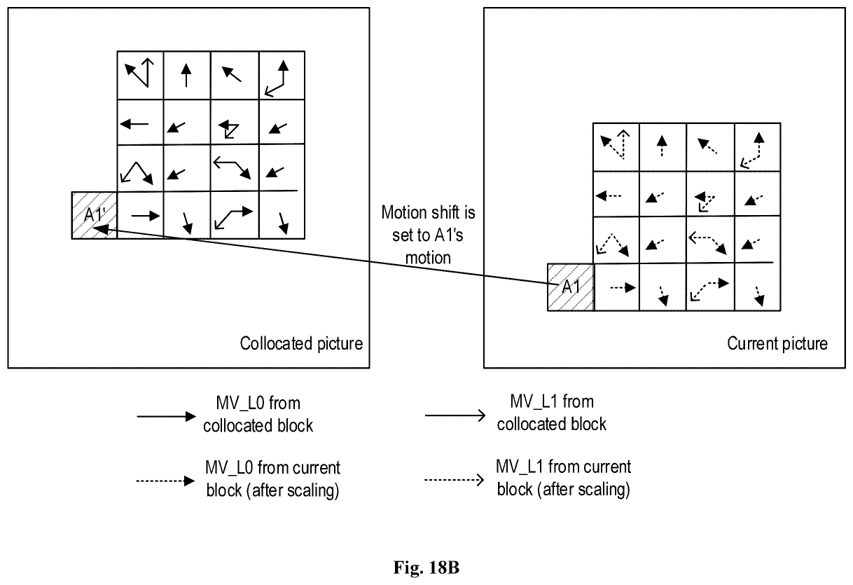

The SbTVMP process is illustrated in FIG. 18A and FIG. 18B. SbTMVP predicts the motion vectors of the sub-CUs within the current CU in two steps. In the first step, the spatial neighbor A1 in FIG. 18A is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e., added to the current block's coordinates) to obtain sub-CU-level motion information (motion vectors and reference indices) from the collocated picture as shown in FIG. 18B. The example in FIG. 18B assumes the motion shift is set to block A1's motion. Then. for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTVMP candidate and affine merge candidates is used for the signalling of subblock based merge mode. The SbTVMP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in Por B slice, an additional RD check is performed to decide whether to use the SbTMVP candidate.

### 2.12. Adaptive Motion Vector Resolution (AMVR)

In HEVC, motion vector differences (MVDs) (between the motion vector and predicted motion vector of a CU) are signalled in units of quarter-luma-sample when use_integer_mv_flag is equal to 0 in the slice header. In VVC, a CU-level adaptive motion vector resolution (AMVR) scheme is introduced. AMVR allows MVD of the CU to be coded in different precision. Dependent on the mode (normal AMVP mode or affine AVMP mode) for the current CU, the MVDs of the current CU can be adaptively selected as follows:
Normal AMVP mode: quarter-luma-sample, half-luma-sample, integer-luma-sample or four-luma-sample.
Affine AMVP mode: quarter-luma-sample, integer-luma-sample or 1/16 luma-sample.

The CU-level MVD resolution indication is conditionally signalled if the current CU has at least one non-zero MVD component. If all MVD components (that is, both horizontal and vertical MVDs for reference list L0 and reference list L1) are zero, quarter-luma-sample MVD resolution is inferred.

For a CU that has at least one non-zero MVD component, a first flag is signalled to indicate whether quarter-luma-sample MVD precision is used for the CU. If the first flag is 0, no further signaling is needed and quarter-luma-sample MVD precision is used for the current CU. Otherwise, a second flag is signalled to indicate half-luma-sample or other MVD precisions (integer or four-luma sample) is used for normal AMVP CU. In the case of half-luma-sample, a 6-tap interpolation filter instead of the default 8-tap interpolation filter is used for the half-luma sample position. Otherwise, a third flag is signalled to indicate whether integer-luma-sample or four-luma-sample MVD precision is used for normal AMVP CU. In the case of affine AMVP CU, the second flag is used to indicate whether integer-luma-sample or 1/16 luma-sample MVD precision is used. In order to ensure the reconstructed MV has the intended precision (quarter-luma-sample, half-luma-sample, integer-luma-sample or four-luma-sample), the motion vector predictors for the CU will be rounded to the same precision as that of the MVD before being added together with the MVD. The motion vector predictors are rounded toward zero (that is, a negative motion vector predictor is rounded toward positive infinity and a positive motion vector predictor is rounded toward negative infinity).

The encoder determines the motion vector resolution for the current CU using RD check. To avoid always performing CU-level RD check four times for each MVD resolution, in VTM11, the RD check of MVD precisions other than quarter-luma-sample is only invoked conditionally. For normal AVMP mode, the RD cost of quarter-luma-sample MVD precision and integer-luma sample MV precision is computed first. Then, the RD cost of integer-luma-sample MVD precision is compared to that of quarter-luma-sample MVD precision to decide whether it is necessary to further check the RD cost of four-luma-sample MVD precision. When the RD cost for quarter-luma-sample MVD precision is much smaller than that of the integer-luma-sample MVD precision, the RD check of four-luma-sample MVD precision is skipped. Then, the check of half-luma-sample MVD precision is skipped if the RD cost of integer-luma-sample MVD precision is significantly larger than the best RD cost of previously tested MVD precisions. For affine AMVP mode, if affine inter mode is not selected after checking rate-distortion costs of affine merge/skip mode, merge/skip mode, quarter-luma-sample MVD precision normal AMVP mode and quarter-luma-sample MVD precision affine AMVP mode, then 1/16 luma-sample MV precision and 1-pel MV precision affine inter modes are not checked. Furthermore, affine parameters obtained in quarter-luma-sample MV precision affine inter mode is used as starting search point in 1/16 luma-sample and quarter-luma-sample MV precision affine inter modes.

### 2.13. Bi-Prediction With CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) ≫ 3. \qquad ( 2 - 18 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used.
At the encoder, fast search algorithms are applied to find the weight index without significantly increasing the encoder complexity. These algorithms are summarized as follows. For further details readers are referred to the VTM software. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g., equal weight.

### 2.14. Local Illumination Compensation (LIC)

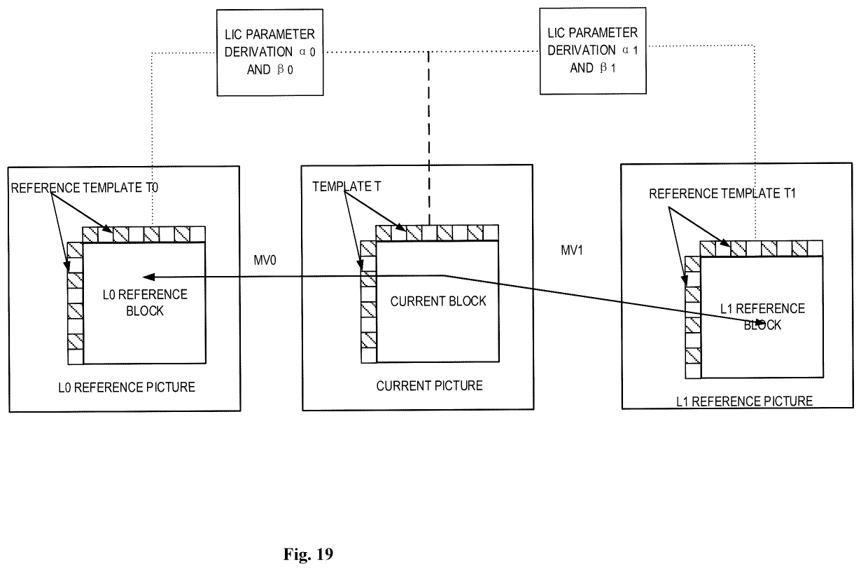

Local illumination compensation (LIC) is a coding tool to address the issue of local illumination changes between current picture and its temporal reference pictures. The LIC is based on a linear model where a scaling factor and an offset are applied to the reference samples to obtain the prediction samples of a current block. Specifically, the LIC can be mathematically modeled by the following equation:

$$P ( x , y ) = α \cdot {P}_{r} ( x + {v}_{x} , y + {v}_{y} ) + β$$

where P(x, y) is the prediction signal of the current block at the coordinate (x, y); Pᵣ(x+vₓ, y+v_{y}) is the reference block pointed by the motion vector (vₓ, v_{y}); α and β are the corresponding scaling factor and offset that are applied to the reference block. FIG. 19 illustrates the LIC process. In FIG. 19, when the LIC is applied for a block, a least mean square error (LMSE) method is employed to derive the values of the LIC parameters (i.e., α and β) by minimizing the difference between the neighboring samples of the current block (i.e., the template T in FIG. 19) and their corresponding reference samples in the temporal reference pictures (i.e., either T0 or T1 in FIG. 19). Additionally, to reduce the computational complexity, both the template samples and the reference template samples are subsampled (adaptive subsampling) to derive the LIC parameters, i.e., only the shaded samples in FIG. 19 are used to derive α and β.

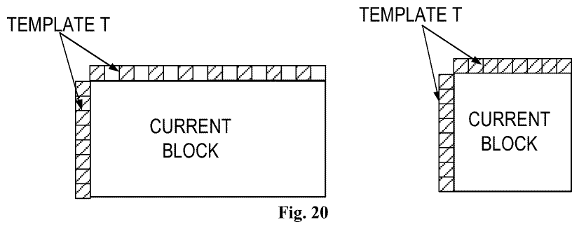

To improve the coding performance, no subsampling for the short side is performed as shown in FIG. 20.

### 2.15. Decoder Side Motion Vector Refinement (DMVR)

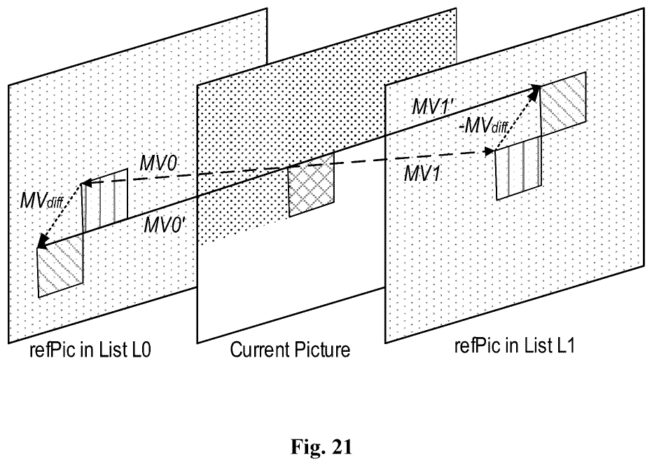

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. As illustrated in FIG. 21, the SAD between the two blocks based on each MV candidate (e.g., MV0′ and MV1′) around the initial MV is calculated.

The MV candidate with the lowest SAD becomes the refined MV and used to generate the bi-predicted signal. In VVC, the application of DMVR is restricted and is only applied for the CUs which are coded with following modes and features:
CU level merge mode with bi-prediction MV.
One reference picture is in the past and another reference picture is in the future with respect to the current picture.
The distances (i.e. POC difference) from two reference pictures to the current picture are same.
Both reference pictures are short-term reference pictures.
CU has more than 64 luma samples.
Both CU height and CU width are larger than or equal to 8 luma samples.
BCW weight index indicates equal weight.
WP is not enabled for the current block.
CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

### 2.15.1. Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset , \qquad ( 2 - 19 )$$

$$MV {1}^{′} = MV 1 - MV\_offset . \qquad ( 2 - 20 )$$

Where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied. In parametric error surface based sub-pixel offsets estimation, the center position cost and the costs at four neighboring positions from the center are used to fit a 2-D parabolic error surface equation of the following form

$$E ( x , y ) = {A ( x - {x}_{m i n} )}^{2} + {B ( y - {y}_{m i n} )}^{2} + C \qquad ( 2 - 21 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{m i n} = ( E ( - 1 , 0 ) - E ( 1 , 0 ) ) / ( 2 ( E ( - 1 , 0 ) + E ( 1 , 0 ) - 2 E ( 0 , 0 ) ) ) , \qquad ( 2 - 22 )$$

$${y}_{m i n} = ( E ( 0 , - 1 ) - E ( 0 , 1 ) ) / ( 2 ( ( E ( 0 , - 1 ) + E ( 0 , 1 ) - 2 E ( 0 , 0 ) ) ) . \qquad ( 2 - 23 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### 2.15.2. Bilinear-Interpolation and Sample Padding

In VVC, the resolution of the MVs is 1/16 luma samples. The samples at the fractional position are interpolated using an 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### 2.15.3. Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### 2.16. Multi-Pass Decoder-Side Motion Vector Refinement

In this contribution, a multi-pass decoder-side motion vector refinement is applied instead of DMVR. In the first pass, bilateral matching (BM) is applied to a coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### 2.16.1. First Pass-Block Based Bilateral Matching MV Refinement

In the first pass, a refined MV is derived by applying BM to a coding block. Similar to decoder-side motion vector refinement (DMVR), the refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV and half-pel sample precision halfDeltaMv. The local search applies a 3×3 square search pattern to loop through the search range [−sHor, sHor] in a horizontal direction and [−sVer, sVer] in a vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, MRSAD cost function is applied to remove the DC effect of the distortion between the reference blocks. When the bilCost at the center point of the 3×3 search pattern has the minimum cost, the intDeltaMV or halfDeltaMV local search is terminated. Otherwise, the current minimum cost search point becomes the new center point of the 3×3 search pattern and the search for the minimum cost continues, until it reaches the end of the search range.

The existing fractional sample refinement is further applied to derive the final deltaMV. The refined MVs after the first pass are then derived as:

$$MV0\_pass1 = MV 0 + deltaMV , \\ MV1\_pass1 = MV 1 - deltaMV .$$

### 2.16.2. Second Pass-Subblock Based Bilateral Matching MV Refinement

In the second pass, a refined MV is derived by applying BM to a 16×16 grid subblock. For each subblock, the refined MV is searched around the two MVs (MV0_pass1 and MV1_pass1), obtained on the first pass for the reference picture list L0 and L1. The refined MVs (MV0_pass2(sbIdx2) and MV1_pass2(sbIdx2)) are derived based on the minimum bilateral matching cost between the two reference subblocks in L0 and L1.

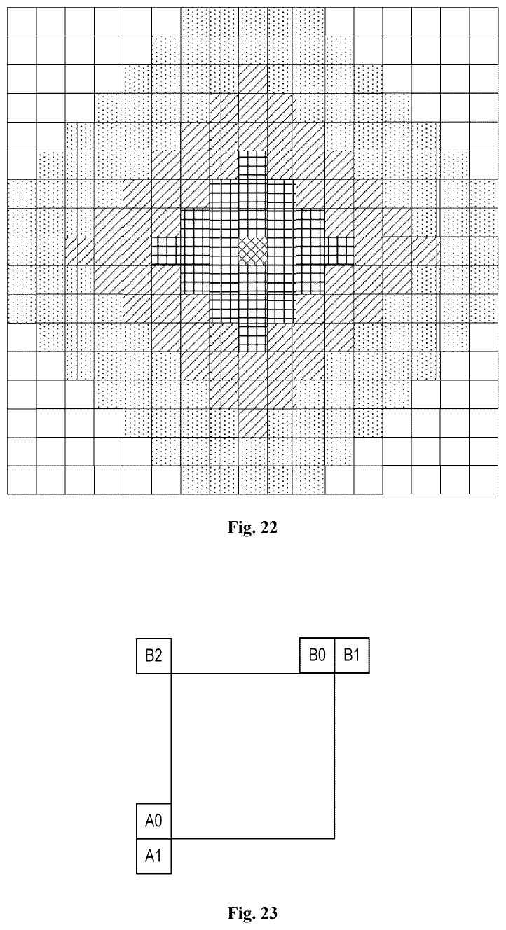

For each subblock, BM performs full search to derive integer sample precision intDeltaMV. The full search has a search range [−sHor, sHor] in a horizontal direction and [−sVer, sVer] in a vertical direction, wherein, the values of sHor and sVer are determined by the block dimension, and the maximum value of sHor and sVer is 8. The bilateral matching cost is calculated by applying a cost factor to the SATD cost between the two reference subblocks, as: bilCost=satdCost*costFactor. The search area (2*sHor+1)*(2*sVer+1) is divided up to 5 diamond shape search regions shown on FIG. 22. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined.

BM performs local search to derive half sample precision halfDeltaMv. The search pattern and cost function are the same as defined in 2.9.1.

The existing VVC DMVR fractional sample refinement is further applied to derive the final deltaMV (sbIdx2).

The refined MVs at second pass is then derived as:

$$MV0\_pass2 ( sbIdx 2 ) = MV0\_pass1 + d e l t a M V ( s b Idx 2 ) ,$$

$$MV1\_pass2 ( s b Idx 2 ) = MV1\_pass1 - d e l t a M V ( s b Idx 2 ) .$$

### 2.16.3. Third Pass-Subblock Based Bi-Directional Optical Flow MV Refinement

In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32.

The refined MVs (MV0_pass3(sbIdx3) and MV1_pass3(sbIdx3)) at third pass are derived as:

$$MV0\_pass3 ( s b Idx 3 ) = MV0\_pass2 ( s b Idx 2 ) + bioMv ,$$

$$MV1\_pass3 ( s b Idx 3 ) = MV0\_pass2 ( s b Idx 2 ) - bioMv .$$

### 2.17. Sample-based BDOF

In the sample-based BDOF, instead of deriving motion refinement (Vx, Vy) on a block basis, it is performed per sample.

The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive Vx and Vy. The derived motion refinement (Vx, Vy) is applied to adjust the bi-predicted sample value for the center sample of the window.

### 2.18. Extended Merge Prediction

In VVC, the merge candidate list is constructed by including the following five types of candidates in order:
(1) Spatial MVP from spatial neighbour CUs.
(2) Temporal MVP from collocated CUs.
(3) History-based MVP from a FIFO table.
(4) Pairwise average MVP.
(5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.18.1. Spatial Candidates Derivation

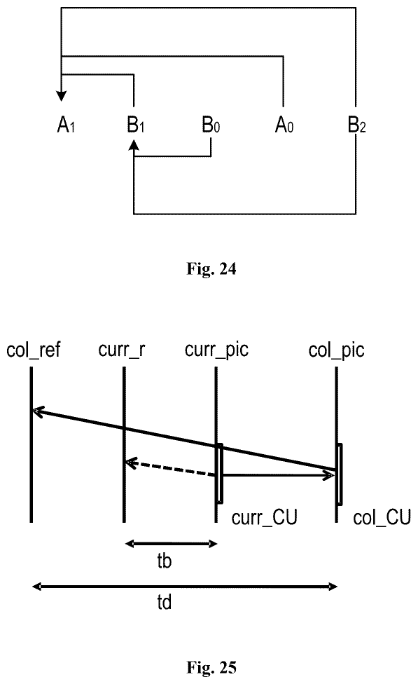

The derivation of spatial merge candidates in VVC is same to that in HEVC except the positions of first two merge candidates are swapped. A maximum of four merge candidates are selected among candidates located in the positions depicted in FIG. 23. The order of derivation is B0, A0, B1, A1 and B2. Position B2 is considered only when one or more than one CUs of position B0, A0, B1, A1 are not available (e.g. because it belongs to another slice or tile) or is intra coded. After candidate at position A1 is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. Instead only the pairs linked with an arrow in FIG. 24 are considered and a candidate is only added to the list if the corresponding candidate used for redundancy check has not the same motion information.

### 2.18.2. Temporal Candidates Derivation

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in FIG. 25, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C0 and C1, as depicted in FIG. 26. If CU at position C0 is not available, is intra coded, or is outside of the current row of CTUs, position C1 is used. Otherwise, position C0 is used in the derivation of the temporal merge candidate.

### 2.18.3. History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 6 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy check operations, the following simplifications are introduced:

Number of HMPV candidates is used for merge list generation is set as (N<=4)? M: (8−N), wherein N indicates number of existing candidates in the merge list and M indicates number of available HMVP candidates in the table.

Once the total number of available merge candidates reaches the maximally allowed merge candidates minus 1, the merge candidate list construction process from HMVP is terminated.

### 2.18.4. Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.

When the merge list is not full after pair-wise average merge candidates are added, the zero MVPs are inserted in the end until the maximum merge candidate number is encountered.

### 2.18.5. Merge Estimation Region

Merge estimation region (MER) allows independent derivation of merge candidate list for the CUs in the same merge estimation region (MER). A candidate block that is within the same MER to the current CU is not included for the generation of the merge candidate list of the current CU. In addition, the updating process for the history-based motion vector predictor candidate list is updated only if (xCb+cbWidth)>>Log2ParMrgLevel is greater than xCb>>Log2ParMrgLevel and (yCb+cbHeight)>>Log2ParMrgLevel is great than (yCb>>Log2ParMrgLevel) and where (xCb, yCb) is the top-left luma sample position of the current CU in the picture and (cbWidth, cbHeight) is the CU size. The MER size is selected at encoder side and signalled as log2_parallel_merge_level_minus2 in the sequence parameter set.

### 2.19. New Merge Candidates

### 2.19.1. Non-Adjacent Merge Candidates Derivation

In VVC, five spatially neighboring blocks shown in FIG. 27 as well as one temporal neighbor are used to derive merge candidates.

It is proposed to derive the additional merge candidates from the positions non-adjacent to the current block using the same pattern as that in VVC. To achieve this, for each search round i, a virtual block is generated based on the current block as follows:

First, the relative position of the virtual block to the current block is calculated by:

$$Offsetx = - i \times gridX , Offsety = - i \times gridY$$

where the Offsetx and Offsety denote the offset of the top-left corner of the virtual block relative to the top-left corner of the current block, gridX and gridY are the width and height of the search grid.

Second, the width and height of the virtual block are calculated by:

$$newWidth = i \times 2 \times gridX + currWidth newHeight = i \times 2 \times gridY + currHeight .$$

where the currWidth and currHeight are the width and height of current block. The newWidth and newHeight are the width and height of new virtual block.

gridX and gridY are currently set to currWidth and currHeight, respectively.

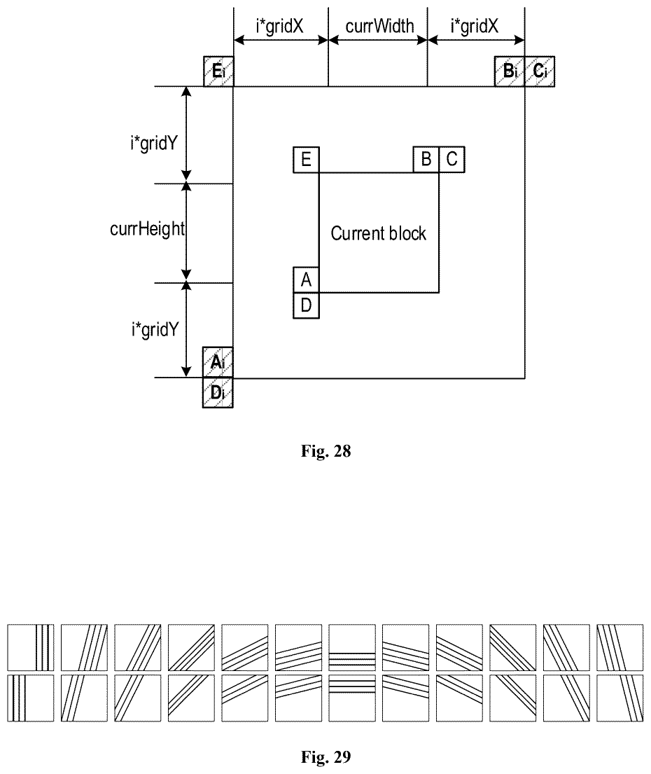

FIG. 28 illustrates the relationship between the virtual block and the current block.

After generating the virtual block, the blocks Aᵢ, Bᵢ, Cᵢ, Dᵢ and Eᵢ can be regarded as the VVC spatial neighboring blocks of the virtual block and their positions are obtained with the same pattern as that in VVC. Obviously, the virtual block is the current block if the search round i is 0. In this case, the blocks Aᵢ, Bᵢ, Cᵢ, Dᵢ and Eᵢ are the spatially neighboring blocks that are used in VVC merge mode.

When constructing the merge candidate list, the pruning is performed to guarantee each element in merge candidate list to be unique. The maximum search round is set to 1, which means that five non-adjacent spatial neighbor blocks are utilized.

Non-adjacent spatial merge candidates are inserted into the merge list after the temporal merge candidate in the order of B₁->A₁->C₁->D₁->E₁.

### 2.19.2. STMVP

It is proposed to derive an averaging candidate as STMVP candidate using three spatial merge candidates and one temporal merge candidate.

STMVP is inserted before the above-left spatial merge candidate.

The STMVP candidate is pruned with all the previous merge candidates in the merge list.

For the spatial candidates, the first three candidates in the current merge candidate list are used.

For the temporal candidate, the same position as VTM/HEVC collocated position is used.

For the spatial candidates, the first, second, and third candidates inserted in the current merge candidate list before STMVP are denoted as F, S, and T.

The temporal candidate with the same position as VTM/HEVC collocated position used in TMVP is denoted as Col.

The motion vector of the STMVP candidate in prediction direction X (denoted as mvLX) is derived as follows:
1) If the reference indices of the four merge candidates are all valid and are all equal to zero in prediction direction X (X=0 or 1),

$$mvLX = ( mvLX\_F + mvLX\_S + mvLX\_T + mvLX\_Col ) ≫ 2.$$

2) If reference indices of three of the four merge candidates are valid and are equal to zero in prediction direction X (X=0 or 1),

$$mvLX = ( mvLX\_F \times 3 + mvLX\_S \times 3 + mvLX\_Col \times 2 ) >> 3 or$$

$$mvLX = ( mvLX\_F \times 3 + mvLX\_T \times 3 + mvLX\_Col \times 2 ) >> 3 or$$

$$mvLX = ( mvLX\_S \times 3 + mvLX\_T \times 3 + mvLX\_Col \times 2 ) >> 3.$$

3) If reference indices of two of the four merge candidates are valid and are equal to zero in prediction direction X (X=0 or 1),

$$mvLX = ( mvLX\_F + mvLX\_Col ) >> 1 or$$

$$mvLX = ( mvLX\_S + mvLX\_Col ) >> 1 or$$

$$mvLX = ( mvLX\_T + mvLX\_Col ) >> 1.$$

Note: If the temporal candidate is unavailable, the STMVP mode is off.

### 2.19.3. Merge List Size

If considering both non-adjacent and STMVP merge candidates, the size of merge list is signalled in sequence parameter set header and the maximum allowed size of merge list is 8.

### 2.20. Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

When this mode is used, a CU is split into two parts by a geometrically located straight line (FIG. 29). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU. The uni-prediction motion for each partition is derived using the process described in section 2.20.1.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights as in section 2.20.2. This is the prediction signal for the whole CU, and transform and quantization process will be applied to the whole CU as in other prediction modes. Finally, the motion field of a CU predicted using the geometric partition modes is stored as in section 2.20.3.

### 2.20.1. Uni-Prediction Candidate List Construction

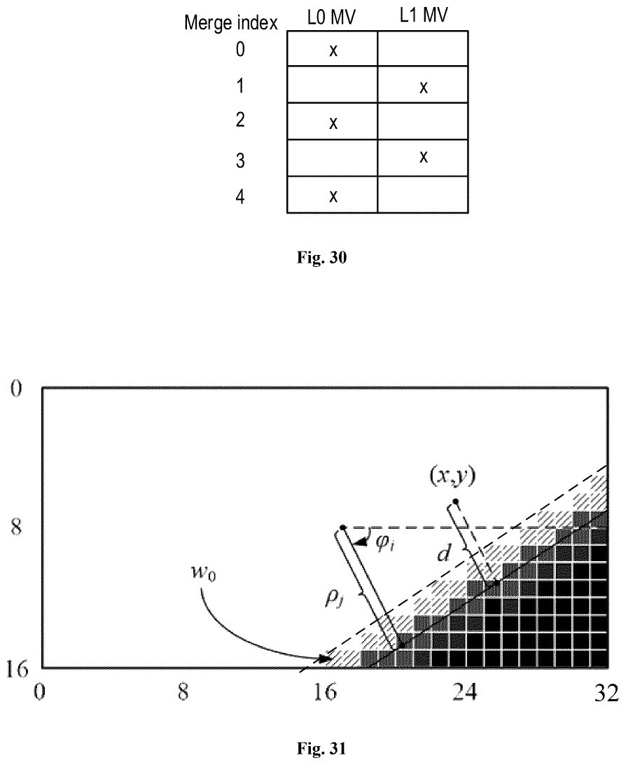

The uni-prediction candidate list is derived directly from the merge candidate list constructed according to the extended merge prediction process in section 2.18. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 30. In case a corresponding LX motion vector of the n-the extended merge candidate does not exist, the L(1−X) motion vector of the same candidate is used instead as the uni-prediction motion vector for geometric partitioning mode.

### 2.20.2. Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 2 - 24 )$$

$${ρ}_{j} = {ρ}_{x , j} cos ( {φ}_{i} ) + {ρ}_{y , j} sin ( {φ}_{i} ) \qquad ( 2 - 25 )$$

$${ρ}_{x , j} = \{ \begin{matrix}0 & i \% 16 = 8 or ( i \% 16 \neq 0 and h \geq w ) \\ \pm ( j \times w ) ≫ 2 & otherwise\end{matrix} \qquad ( 2 - 26 )$$

$${ρ}_{y , j} = \{ \begin{matrix}\pm ( j \times h ) ≫ 2 & i \% 16 = 8 or ( i \% 16 \neq 0 and h \geq w ) \\ 0 & otherwise\end{matrix} \qquad ( 2 - 27 )$$

where i, j are the indices for angle and offset of a geometric partition, which depend on the signaled geometric partition index. The sign of ρ_{x, j} and ρ_{y, j} depend on angle index i.

The weights for each part of a geometric partition are derived as following:

$$wIdxL ( x , y ) = partIdx ? 32 + d ( x , y ) : 32 - d ( x , y ) \qquad ( 2 - 28 )$$

$${w}_{0} ( x , y ) = \frac{C lip 3 ( 0 , 8 , ( wIdxL ( x , y ) + 4 ) ≫ 3 )}{8} \qquad ( 2 - 29 )$$

$${w}_{1} ( x , y ) = 1 - {w}_{0} ( x , y ) . \qquad ( 2 - 30 )$$

The partIdx depends on the angle index i. One example of weigh w₀ is illustrated in FIG. 31.

### 2.20.3. Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU. The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 2 - 31 )$$

where motionIdx is equal to d(4x+2, 4y+2), which is recalculated from equation (2-18). The partIdx depends on the angle index i.

If sType is equal to 0 or 1, Mv0 or Mv1 are stored in the corresponding motion field, otherwise if sType is equal to 2, a combined Mv from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
   Otherwise, if Mv1 and Mv2 are from the same list, only uni-prediction motion Mv2 is stored.

### 2.21. Multi-Hypothesis Prediction

In multi-hypothesis prediction (MHP), up to two additional predictors are signalled on top of inter AMVP mode, regular merge mode, affine merge and MMVD mode. The resulting overall prediction signal is accumulated iteratively with each additional prediction signal.

$${p}_{n + 1} = ( 1 - {α}_{n + 1} ) {p}_{n} + {α}_{n + 1} {h}_{n + 1}$$

The weighting factor a is specified according to the following Table 2-4.

TABLE 2-4
weighting factor for MHP

| add_hyp_weight_idx | α |
|---|---|
| 0 | ¼ |
| 1 | −⅛ |

For inter AMVP mode, MHP is only applied if non-equal weight in BCW is selected in bi-prediction mode. The additional hypothesis can be either merge or AMVP mode. In the case of merge mode, the motion information is indicated by a merge index, and the merge candidate list is the same as in the Geometric Partition Mode. In the case of AMVP mode, the reference index, MVP index, and MVD are signaled.

### 2.22. Non-Adjacent Spatial Candidate

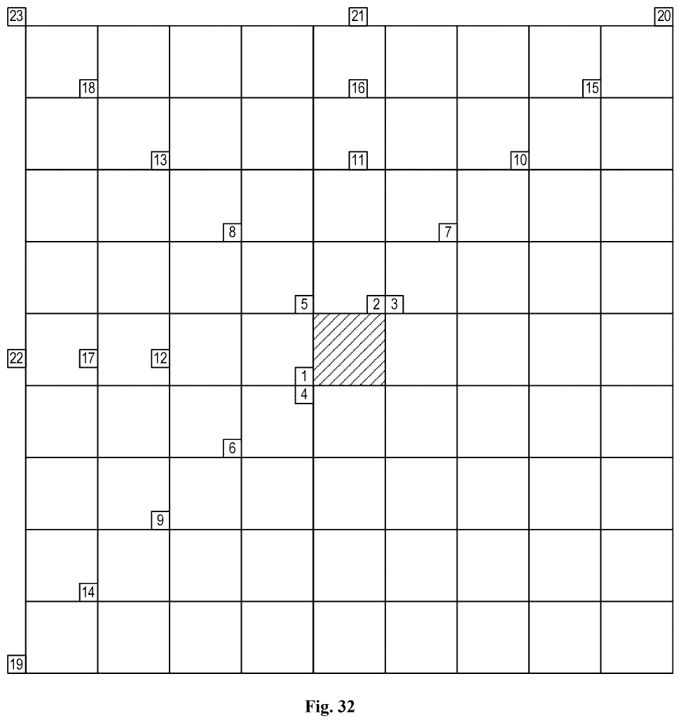

The non-adjacent spatial merge candidates are inserted after the TMVP in the regular merge candidate list. The pattern of the spatial merge candidates is shown on FIG. 32. The distances between the non-adjacent spatial candidates and the current coding block are based on the width and height of the current coding block.

### 2.23. Template Matching (TM)

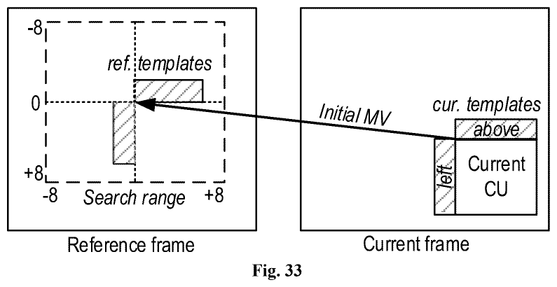

Template matching (TM) is a decoder-side MV derivation method to refine the motion information of the current CU by finding the closest match between a template (i.e., top and/or left neighbouring blocks of the current CU) in the current picture and a block (i.e., same size to the template) in a reference picture. As illustrated in FIG. 33, a better MV is to be searched around the initial motion of the current CU within a [−8, +8]-pel search range. The template matching that was proposed two modifications: search step size is determined based on AMVR mode and TM can be cascaded with bilateral matching process in merge modes.

In AMVP mode, an MVP candidate is determined based on template matching error to pick up the one which reaches the minimum difference between current block template and reference block template, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode as specified in Table 2-5. This search process ensures that the MVP candidate still keeps the same MV precision as indicated by AMVR mode after TM process.

TABLE 2-5
Search patterns of AMVR and merge mode with AMVR.

| Search | AMVR mode | | | | Merge mode | |
|---|---|---|---|---|---|---|
| pattern | 4-pel | Full-pel | Half-pel | Quarter-pel | AltIF = 0 | AltIF = 1 |
| 4-pel diamond | v | | | | | |
| 4-pel cross | v | | | | | |
| Full-pel | | v | v | v | v | v |
| diamond | | | | | | |
| Full-pel cross | | v | v | v | v | v |
| Half-pel cross | | | v | v | v | v |
| Quarter-pel | | | | v | v | |
| cross | | | | | | |
| ⅛-pel cross | | | | | v | |

In merge mode, similar search method is applied to the merge candidate indicated by the merge index. As Table 2-5 shows, TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

### 2.24. Overlapped Block Motion Compensation (OBMC)

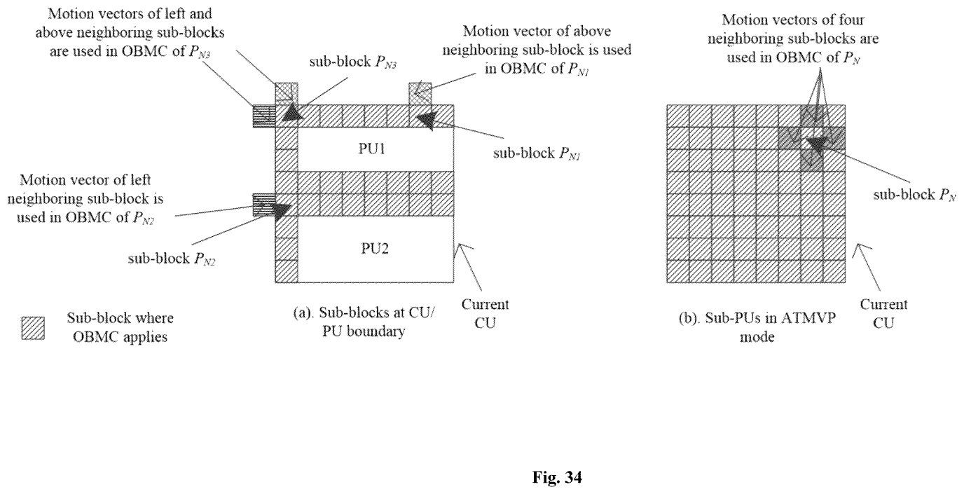

Overlapped Block Motion Compensation (OBMC) has previously been used in H.263. In the JEM, unlike in H.263, OBMC can be switched on and off using syntax at the CU level. When OBMC is used in the JEM, the OBMC is performed for all motion compensation (MC) block boundaries except the right and bottom boundaries of a CU. Moreover, it is applied for both the luma and chroma components. In the JEM, a MC block is corresponding to a coding block. When a CU is coded with sub-CU mode (includes sub-CU merge, affine and FRUC mode), each sub-block of the CU is a MC block. To process CU boundaries in a uniform fashion, OBMC is performed at sub-block level for all MC block boundaries, where sub-block size is set equal to 4×4, as illustrated in FIG. 34.

When OBMC applies to the current sub-block, besides current motion vectors, motion vectors of four connected neighbouring sub-blocks, if available and are not identical to the current motion vector, are also used to derive prediction block for the current sub-block. These multiple prediction blocks based on multiple motion vectors are combined to generate the final prediction signal of the current sub-block.

Prediction block based on motion vectors of a neighbouring sub-block is denoted as P_{N}, with N indicating an index for the neighbouring above, below, left and right sub-blocks and prediction block based on motion vectors of the current sub-block is denoted as P_{C}. When P_{N} is based on the motion information of a neighbouring sub-block that contains the same motion information to the current sub-block, the OBMC is not performed from P_{N}. Otherwise, every sample of P_{N} is added to the same sample in P_{C}, i.e., four rows/columns of P_{N} are added to P_{C}. The weighting factors {¼, ⅛, 1/16, 1/32} are used for PN and the weighting factors {¾, ⅞, 15/16, 31/32} are used for P_{C}. The exception are small MC blocks, (i.e., when height or width of the coding block is equal to 4 or a CU is coded with sub-CU mode), for which only two rows/columns of P_{N} are added to P_{C}. In this case weighting factors {¼, ⅛} are used for PN and weighting factors {¾, ⅞} are used for P_{C}. For P_{N} generated based on motion vectors of vertically (horizontally) neighbouring sub-block, samples in the same row (column) of P_{N} are added to P_{C} with a same weighting factor.

In the JEM, for a CU with size less than or equal to 256 luma samples, a CU level flag is signalled to indicate whether OBMC is applied or not for the current CU. For the CUs with size larger than 256 luma samples or not coded with AMVP mode, OBMC is applied by default. At the encoder, when OBMC is applied for a CU, its impact is taken into account during the motion estimation stage. The prediction signal formed by OBMC using motion information of the top neighbouring block and the left neighbouring block is used to compensate the top and left boundaries of the original signal of the current CU, and then the normal motion estimation process is applied.

### 2.25. Multiple Transform Selection (MTS) for Core Transform

In addition to DCT-II which has been employed in HEVC, a Multiple Transform Selection (MTS) scheme is used for residual coding both inter and intra coded blocks. It uses multiple selected transforms from the DCT8/DST7. The newly introduced transform matrices are DST-VII and DCT-VIII. Table 2-6 shows the basis functions of the selected DST/DCT.

TABLE 2-6
Transform basis functions of DCT-II/VIII and DSTVII for N-point input

| Transform Type | Basis function Tᵢ(j), i, j = 0, 1, . . . , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit.

In order to control MTS scheme, separate enabling flags are specified at SPS level for intra and inter, respectively. When MTS is enabled at SPS, a CU level flag is signalled to indicate whether MTS is applied or not. Here, MTS is applied only for luma. The MTS signaling is skipped when one of the below conditions is applied.
The position of the last significant coefficient for the luma TB is less than 1 (i.e., DC only).
The last significant coefficient of the luma TB is located inside the MTS zero-out region.

If MTS CU flag is equal to zero, then DCT2 is applied in both directions. However, if MTS CU flag is equal to one, then two other flags are additionally signalled to indicate the transform type for the horizontal and vertical directions, respectively. Transform and signalling mapping table as shown in Table 2-7. Unified the transform selection for ISP and implicit MTS is used by removing the intra-mode and block-shape dependencies. If current block is ISP mode or if the current block is intra block and both intra and inter explicit MTS is on, then only DST7 is used for both horizontal and vertical transform cores. When it comes to transform matrix precision, 8-bit primary transform cores are used. Therefore, all the transform cores used in HEVC are kept as the same, including 4-point DCT-2 and DST-7, 8-point, 16-point and 32-point DCT-2. Also, other transform cores including 64-point DCT-2, 4-point DCT-8, 8-point, 16-point, 32-point DST-7 and DCT-8, use 8-bit primary transform cores.

TABLE 2-7
Transform and signalling mapping table

| MTS_CU_{—} | MTS_Hor_{—} | MTS_Ver_{—} | Intra/inter | |
|---|---|---|---|---|
| flag | flag | flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, High frequency transform coefficients are zeroed out for the DST-7 and DCT-8 blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST or MIP is activated for the current CU. Also the implicit MTS can be still enabled when MTS is enabled for inter coded blocks.

### 2.26. Subblock Transform (SBT)

In VTM, subblock transform is introduced for an inter-predicted CU. In this transform mode, only a sub-part of the residual block is coded for the CU. When inter-predicted CU with cu_cbf equal to 1, cu_sbt_flag may be signaled to indicate whether the whole residual block or a sub-part of the residual block is coded. In the former case, inter MTS information is further parsed to determine the transform type of the CU. In the latter case, a part of the residual block is coded with inferred adaptive transform and the other part of the residual block is zeroed out.

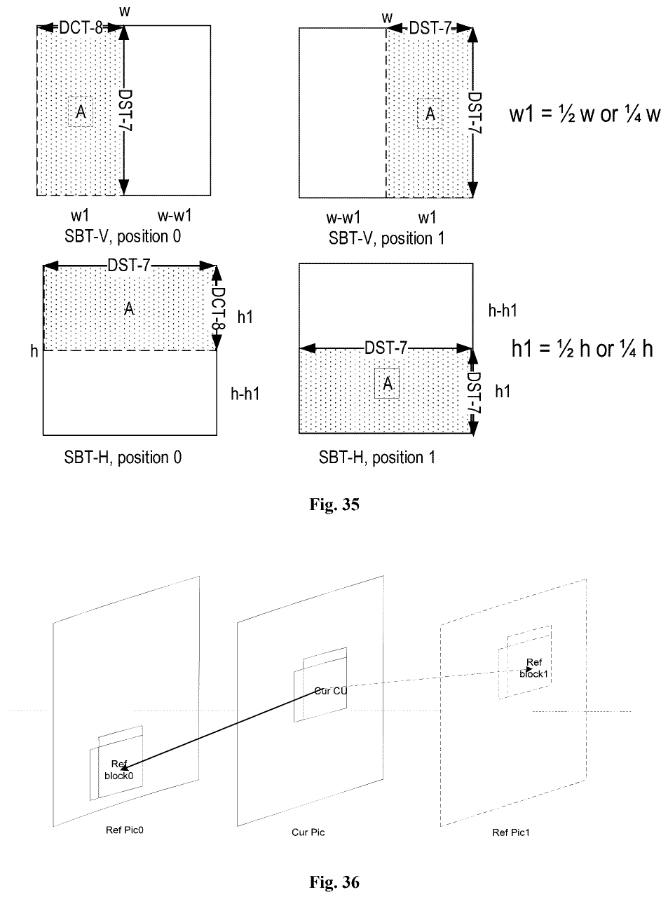

When SBT is used for an inter-coded CU, SBT type and SBT position information are signaled in the bitstream. There are two SBT types and two SBT positions, as indicated in FIG. 35. For SBT-V (or SBT-H), the TU width (or height) may equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is 8 in luma samples, the 1:3/3:1 split along that dimension is disallowed. There are at most 8 SBT modes for a CU.

Position-dependent transform core selection is applied on luma transform blocks in SBT-V and SBT-H (chroma TB always using DCT-2). The two positions of SBT-H and SBT-V are associated with different core transforms. More specifically, the horizontal and vertical transforms for each SBT position is specified in FIG. 35. For example, the horizontal and vertical transforms for SBT-V position 0 is DCT-8 and DST-7, respectively. When one side of the residual TU is greater than 32, the transform for both dimensions is set as DCT-2. Therefore, the subblock transform jointly specifies the TU tiling, cbf, and horizontal and vertical core transform type of a residual block.

The SBT is not applied to the CU coded with combined inter-intra mode.

### 2.27. Template Matching Based Adaptive Merge Candidate Reorder

To improve the coding efficiency, after the merge candidate list is constructed, the order of each merge candidate is adjusted according to the template matching cost. The merge candidates are arranged in the list in accordance with the template matching cost of ascending order. It is operated in the form of sub-group.

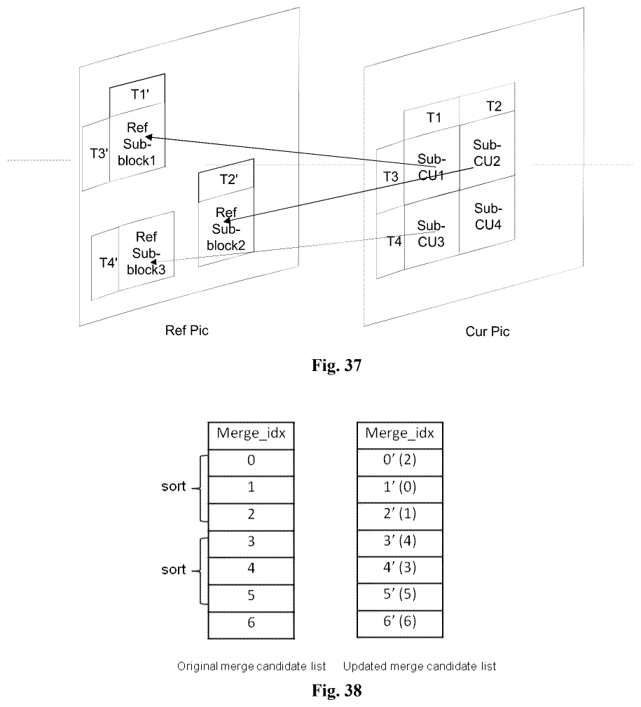

The template matching cost is measured by the SAD (Sum of absolute differences) between the neighbouring samples of the current CU and their corresponding reference samples. If a merge candidate includes bi-predictive motion information, the corresponding reference samples are the average of the corresponding reference samples in reference list0 and the corresponding reference samples in reference list1, as illustrated in FIG. 36. If a merge candidate includes sub-CU level motion information, the corresponding reference samples consist of the neighbouring samples of the corresponding reference sub-blocks, as illustrated in FIG. 37.

The sorting process is operated in the form of sub-group, as illustrated in FIG. 38. The first three merge candidates are sorted together. The following three merge candidates are sorted together.

The template size (width of the left template or height of the above template) is 1. The sub-group size is 3.

### 2.28. Adaptive Merge Candidate List

We can assume the number of the merge candidates is 8. We take the first 5 merge candidates as a first subgroup and take the following 3 merge candidates as a second subgroup (i.e., the last subgroup).

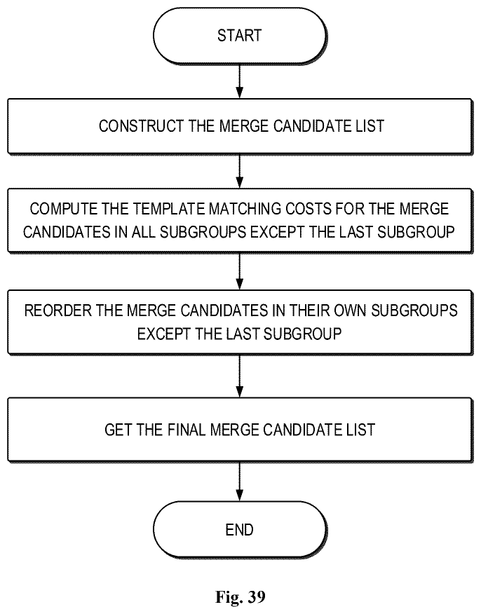

For the encoder, after the merge candidate list is constructed, some merge candidates are adaptively reordered in an ascending order of costs of merge candidates as shown in FIG. 39.

More specifically, the template matching costs for the merge candidates in all subgroups except the last subgroup are computed; then reorder the merge candidates in their own subgroups except the last subgroup; finally, the final merge candidate list will be got.

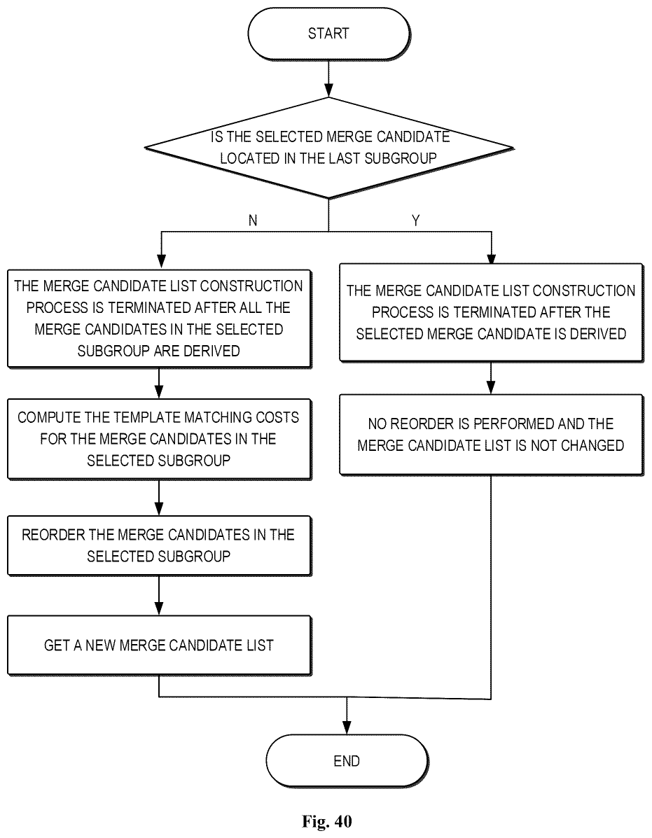

For the decoder, after the merge candidate list is constructed, some/no merge candidates are adaptively reordered in ascending order of costs of merge candidates as shown in FIG. 40. In FIG. 40, the subgroup the selected (signaled) merge candidate located in is called the selected subgroup.

More specifically, if the selected merge candidate is located in the last subgroup, the merge candidate list construction process is terminated after the selected merge candidate is derived, no reorder is performed and the merge candidate list is not changed; otherwise, the execution process is as follows.

The merge candidate list construction process is terminated after all the merge candidates in the selected subgroup are derived; compute the template matching costs for the merge candidates in the selected subgroup; reorder the merge candidates in the selected subgroup; finally, a new merge candidate list will be got.

For both encoder and decoder, a template matching cost is derived as a function of T and RT, wherein T is a set of samples in the template and RT is a set of reference samples for the template.

When deriving the reference samples of the template for a merge candidate, the motion vectors of the merge candidate are rounded to the integer pixel accuracy.

The reference samples of the template (RT) for bi-directional prediction are derived by weighted averaging of the reference samples of the template in reference list0 (RT₀) and the reference samples of the template in reference list1 (RT₁) as follows.

$$R T = ( ( 8 - w ) * R {T}_{0} + w * R {T}_{1} + 4 ) ≫ 3 \qquad ( 2 - 32 )$$

where the weight of the reference template in reference list0 (8−w) and the weight of the reference template in reference list1 (w) are decided by the BCW index of the merge candidate. BCW index equal to {0,1,2,3,4} corresponds to w equal to {−2,3,4,5,10}, respectively.

If the Local Illumination Compensation (LIC) flag of the merge candidate is true, the reference samples of the template are derived with LIC method.

The template matching cost is calculated based on the sum of absolute differences (SAD) of T and RT.

The template size is 1. That means the width of the left template and/or the height of the above template is 1.

If the coding mode is MMVD, the merge candidates to derive the base merge candidates are not reordered.

If the coding mode is GPM, the merge candidates to derive the uni-prediction candidate list are not reordered.

### 2.29. IBC With Extended Reference Area

An IBC reference area design is proposed that does not increase the current memory area required by ECM-3 and tests the performance.

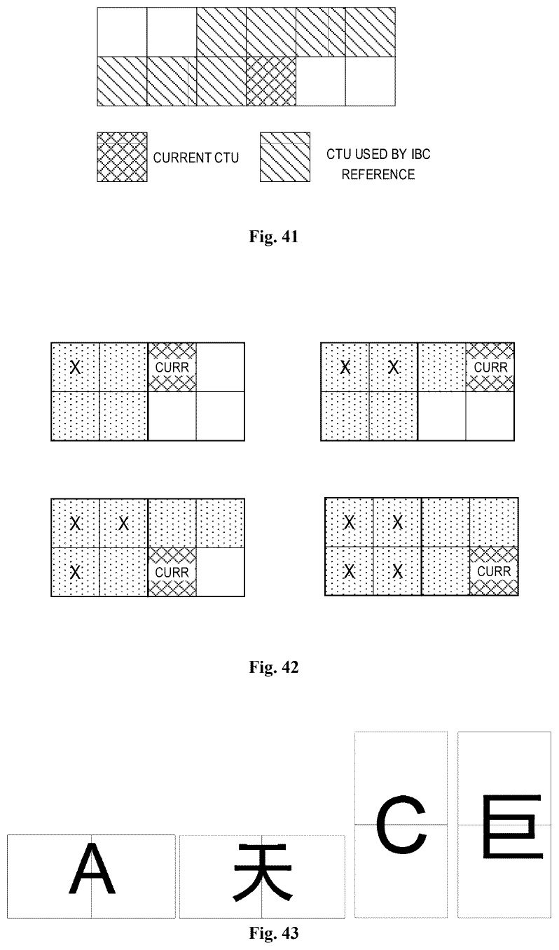

FIG. 41 illustrates the design. In FIG. 41, the dark grey square denotes the current CTU and the light grey ones denote CTUs that may be used by IBC reference. Specifically, assume that W denotes the maximum horizontal CTU index and the current CTU index is (m, n), for coding units in the current CTU, CTUs with index (0, n) . . . (m, n) and (m−1, n) . . . (W, n) defines the reference area that can be used by IBC.

One reason to have such a design is that in the current ECM, the left, above and upper-left CTUs are being used and thus need to be saved. To achieve this, all CTUs to the right of the above CTU in the above CTU row (for CTUs to be coded in the current CTU row) and all CTUs to the left of the current CTU in the current CTU row (for CTUs to be coded in the next CTU row) must be kept. It means that such a design does not increase the buffer size required by the current ECM.

### 2.30. IBC With Template Matching

It is proposed to also use Template Matching with IBC for both IBC merge mode and IBC AMVP mode.

The IBC-TM merge list has been modified compared to the one used by regular IBC merge mode such that the candidates are selected according to a pruning method with a motion distance between the candidates as in the regular TM merge mode. The ending zero motion fulfillment (which is a nonsense regarding Intra coding) has been replaced by motion vectors to the left (−W, 0), top (0, −H) and top-left (−W, −H) CUs, then, if necessary, the list is fulfilled with the left one without pruning.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained to be integer and within a reference region as shown in FIG. 42. So, in IBC-TM merge mode, all refinements are performed at integer precision, and in IBC-TM AMVP mode, they are performed either at integer or 4-pel precision. In both cases, the refined motion vectors in each refinement step must respect the constraint of the reference region.

### 2.31. Reconstruction-Reordered IBC (RR-IBC)

Screen content coding tools like Intra Block Copy (IBC) generate a prediction block by directly copying a prior coded reference region in the same picture. Symmetry is often observed in video content, especially in text character regions and computer-generated graphics in screen content sequences, as shown in FIG. 43. Therefore, a specific screen content coding tool considering the symmetry would be efficient to compress such kinds of video contents.

A Reconstruction-Reordered IBC (RR-IBC) mode is proposed for screen content video coding. When it is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signaled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

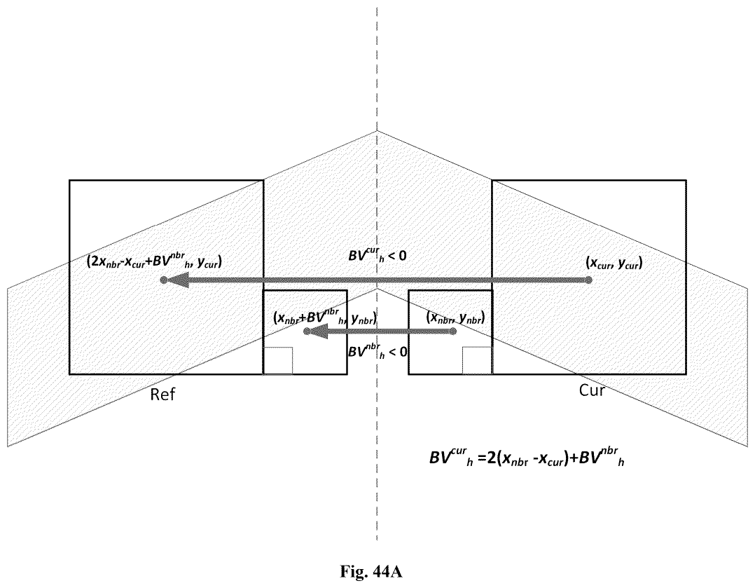

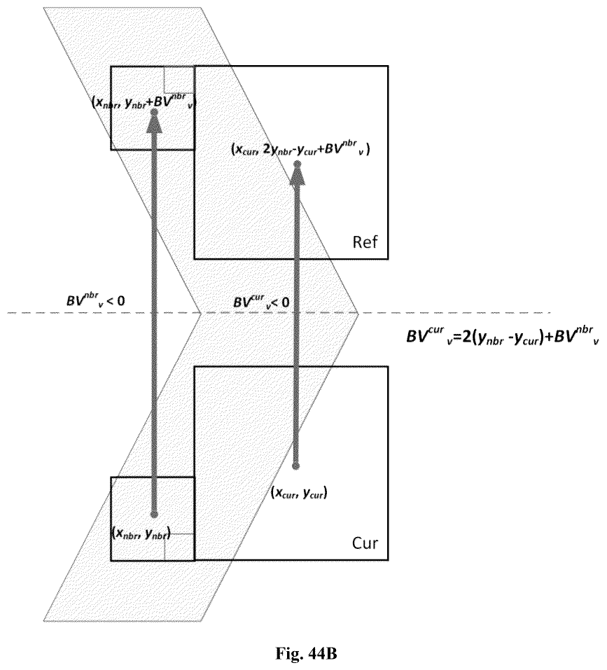

To better utilize the symmetry property, a flip-aware BV adjustment approach is applied to refine the block vector candidate. For example, as shown in FIGS. 44A and 44B, (x_{nbr}, y_{nbr}) and (x_{cur}, y_{cur}) represent the coordinates of the center sample of the neighboring block and the current block, respectively, BV^{nbr} and BV^{cur} denotes the BV of the neighboring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₕ) in case that the neighbouring block is coded with a horizontal flip, i.e., BV^{cur}ₕ=2(x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip, i.e., BV^{cur}ᵥ=2(y_{nbr}−y_{cur})+BV^{nbr}ᵥ.

### 2.32. Intra Template Matching Prediction

Intra template matching prediction (Intra TMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

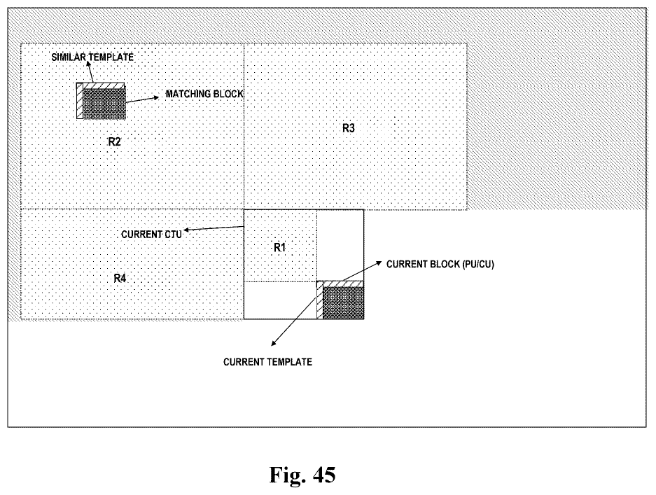

The prediction signal is generated by matching the L-shaped causal neighbor of the current block with another block in a predefined search area in FIG. 45 consisting of:
R1: current CTU,
R2: top-left CTU,
R3: above CTU,
R4: left CTU.
   SAD is used as a cost function.

Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW ,$$

$$SearchRange\_h = a * BlkH ,$$

Where ‘a’ is a constant that controls the gain/complexity trade-off. In practice, ‘a’ is equal to 5.

FIG. 45 illustrates an intra template matching search area used.

The Intra template matching tool is enabled for CUs with size less than or equal to 64 in width and height. This maximum CU size for Intra template matching is configurable.

The Intra template matching prediction mode is signaled at CU level through a dedicated flag when DIMD is not used for current CU.

### 2.33. Intra Prediction Fusion

Intra prediction fusion method uses multiple predictors generated from different modes/reference lines.

In sub-test a, multiple intra predictors are generated and then fused by weighted averaging. The process of deriving the predictors to be used in the fusion process is described as follows:
1) For angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.
2) For TIMD mode with blending, pₗᵢₙₑ is used for the 1^{st} mode (w₀=1, w₁=0) and pₗᵢₙₑ₊₁ is used for the 2^{nd} mode (w₀=0, w₁=1).
3) For DIMD mode with blending, the number of predictors selected for a weighted average is increased from 3 to 6.

In sub-test b, intra prediction fusion is performed on reference lines instead of prediction blocks. Two reference lines (referred to as rₗᵢₙₑ and rₗᵢₙₑ₊₁) are used for intra prediction fusion. DeltaInt of the corresponding intra prediction angle is considered in the fusion process. Each value in the fused reference line (r_{fusion}[i]) is derived from:

$${r}_{f u s i o n} [ i ] = ( 3 \cdot {r}_{l i n e} [ i ] + {r}_{l i n e + 1} [ i + DeltaInt ] ) ≫ 2.$$

The proposed intra prediction fusion is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.

### 2.34. Template-Based Multiple Reference Line Intra Prediction (TMRL)

The proposed TMRL mode includes the following aspects:

### a) Extended Reference Line Candidate List and Intra-Prediction-Mode Candidate List.

The extended reference line candidate list used in this proposal is {1, 3, 5, 7, 12}. The restriction on the top CTU row is unchanged. The size of the intra-prediction-mode candidate list is 10. The construction of the intra-prediction-mode candidate list is similar to MPM. The differences are:

PLANAR mode is excluded from the proposed intra-prediction-mode candidate list.

DC mode is added after the 5 neighboring PUs' modes and DIMD modes if it has not been included.

The angular modes with delta angles from ±1 to ±4 (compared to the existing angular modes in the intra-prediction-mode candidate list) are added.

### b) Construction of the TMRL Candidate List.

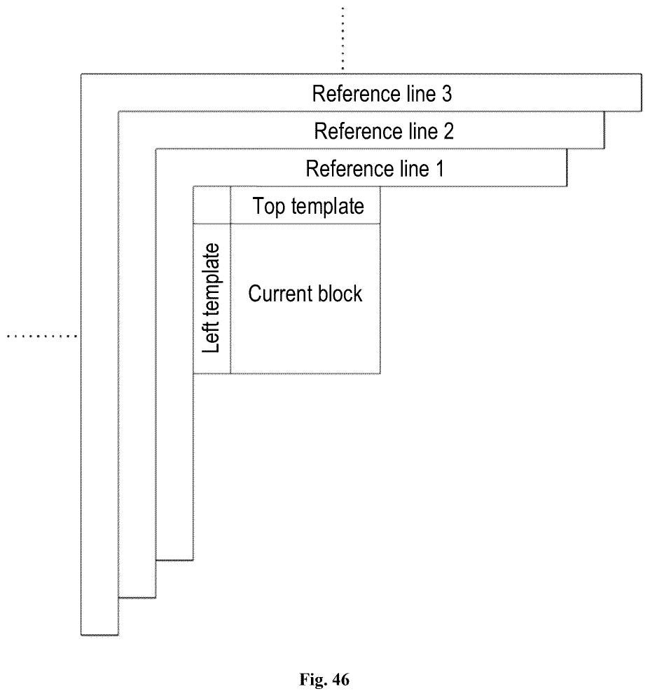

There are 5×10=50 combinations of the extended reference line and the allowed intra-prediction modes for a block. Since the extended reference line starts from reference line 1, the area covered by reference line 0 is used for template matching. The SAD costs over the template area (see FIG. 46) are calculated between the predictions (generated by 50 combinations) and the reconstructions. The 20 combinations with the least SAD cost are selected in an ascending order to form the TMRL candidate list.

### c) Signaling of TMRL

Instead of coding the reference line and the intra mode directly, an index to the TMRL candidate list is coded to indicate which combination of the reference line and prediction mode is used for coding the current block. In the proposed TMRL mode, a truncated Golomb-Rice coding with a divisor 4 is employed to code selected combinations from the combination list. The binarization process and the codewords are shown in Table 2-8.

TABLE 2-8
the binarization process of the TMRL index

| Index | Bin string (prefix) | Bin string (suffix) |
|---|---|---|
| 0 | 0 | 00 |
| 1 | 0 | 01 |
| 2 | 0 | 10 |
| 3 | 0 | 11 |
| 4 | 10 | 00 |
| . . . | . . . | . . . |
| 18 | 1111 | 10 |
| 19 | 1111 | 11 |

### d) Encoder-Side Modifications

Encoder-side modification is tested to further improve the coding efficiency. For intra blocks larger than 8×8, an additional TMRL RDO is added if no TMRL modes are selected by SATD comparison.

### 2.35. Convolutional Cross-Component Model (CCCM) for Intra Prediction

It is proposed to apply convolutional cross-component model (CCCM) to predict chroma samples from reconstructed luma samples in a similar spirit as done by the current CCLM modes. As with CCLM, the reconstructed luma samples are down-sampled to match the lower resolution chroma grid when chroma sub-sampling is used.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

### 2.35.1. Convolutional Filter

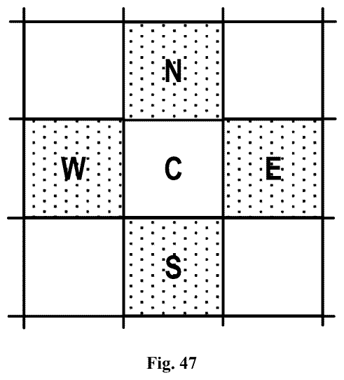

The proposed convolutional 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated below in FIG. 47.

The nonlinear term P is represented as power of two of the center luma sample C and scaled to the sample value range of the content:

$$P = ( C * C + midVal ) >> bitDepth .$$

That is, for 10-bit content it is calculated as:

$$P = ( C * C + 512 ) >> 10.$$

The bias term B represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B .$$

### 2.35.2. Calculation of Filter Coefficients

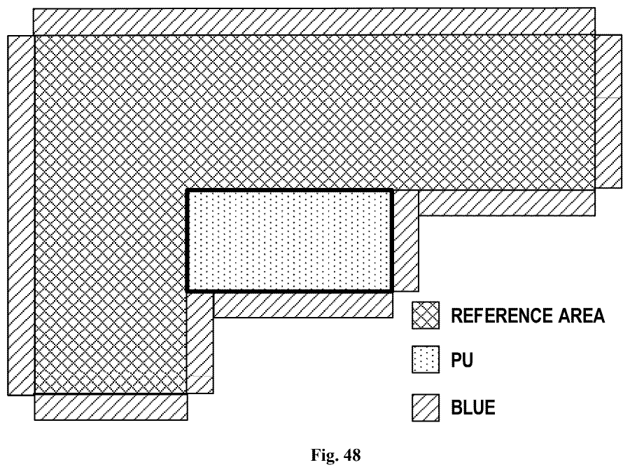

The filter coefficients cᵢ are calculated by minimising MSE between predicted and reconstructed chroma samples in the reference area. FIG. 48 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations. The proposed approach uses only integer arithmetic.

### 2.35.3. Bitstream Signalling

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA_IDX (to enable single mode CCCM) or MMLM_CHROMA_IDX (to enable multi-model CCCM).

### 2.36. Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β .$$

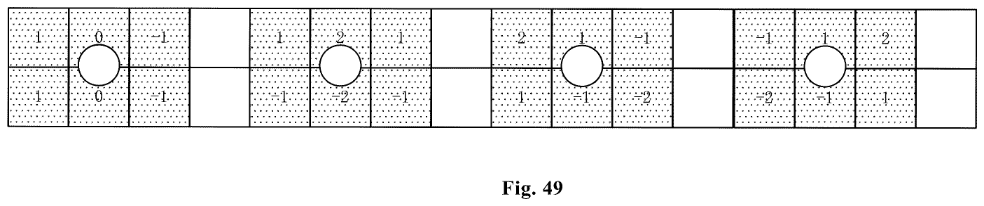

For signaling, when the CCLM mode is enabled to the current CU, two flags are signaled separately for Cb and Cr components to indicate whether GLM is enabled to each component; if the GLM is enabled for one component, one syntax element is further signaled to select one of 4 gradient filters for the gradient calculation.
Four gradient filters are enabled for the GLM, as illustrated in FIG. 49.

### 3. Problems

In current design of IntraTMP, the best prediction block is copied from the reconstructed part of the current frame, whose L-shaped template matches the current template. IntraTMP could be improved from following aspects:
1. Multiple prediction blocks are obtained and one or more of them are used to generate the prediction block of current video unit.
2. Different templates are used.

### 4. Detailed Description

The detailed embodiments below should be considered as examples to explain general concepts. These embodiments should not be interpreted in a narrow way. Furthermore, these embodiments can be combined in any manner. In the present disclsoure, IntraTMP may not be limited to the current IntraTMP technology, but may be interpreted as the technology that reference (or prediction) block is obtained with samples in the current slice/tile/subpicture/picture/other video unit (e.g., CTU row) excluding the conventional intra prediction methods. Candidate/block vector for IntraTMP: a displacement offset relative to the top-left position of the current template of the current block, which refer to the position of the reference template. And the candidate/block vector is used to obtain the prediction block for current block similar to the method in IBC.

In the following discussion, IntraTMP may be replaced by other coding tools that rely on coded/decoded/reconstructed information within the same region, e.g., palette, intra block copy (IBC). In the disclosure, RW, RH, BW, BH denotes the range width, the range height, the block width, the block height, respectively.

### Searching Method for IntraTMP

1. It is proposed to use adaptive search range for IntraTMP.
   a. In one example, RW=(a1×BW+b1)>>s1 and/or RH=(a2×BH+b2)>>s2, wherein a1, b1, s1 and a2, b2, s2 are integers.
   b. In one example, the search range may depend on coding information.
      i. In one example, the search range may depend on the resolution/dimensions of a video unit.
         1) In one example, the search range may depend on the resolution/dimensions of picture.
      ii. In one example, the coding information may refer to the neighbouring video units (e.g., coded mode or residuals), or quantization parameter (QP).
   c. In one example, the search range may depend on the video content (e.g., SCC content or natural content).
   d. In one example, one or more syntax elements may be signalled to indicate the determination of the search range.
2. It is proposed to use one or multiple search regions for IntraTMP.
   a. In one example, the location/position/shape of at least one of the multiple search regions may be adaptive.
   b. In one example, one region may be used.
      i. In one example, all available areas used for searching may belong to one region.
   c. In one example, the number of regions may depend on coding information.
      i. In one example, the coding information may refer to resolution/dimensions of current video unit and/or the neighbouring video units.
   d. In one example, the determination of the number of regions may be signalled in the bitstream.
   e. In one example, the number of regions may depend on the video content.
   f. In one example, the searching order for different regions may be different.
3. It is proposed to use one or more thresholds for early termination in search process of IntraTMP.
   a. In one example, one or more thresholds may be used to stop searching for IntraTMP.
      i. For example, the searching process is terminated if the cost is smaller (or no greater) than a threshold.
   b. In one example, the thresholds may be used in coarse searching.
   c. In one example, the thresholds may be used in refinement searching.
   d. In one example, the thresholds may be different for coarse searching and refinement searching.
   e. In one example, the determination of the thresholds may be pre-defined, or signalled, or derived.
   f. In one example, the thresholds may depend on coding information, such as template size/dimensions, or block size/dimensions, or QP, SAD.
4. It is proposed to use predictive searching for IntraTMP, wherein one or more starting points are used for searching.
   a. In one example, a starting point list may be constructed, and one or more of starting points in the list are used for searching.
      i. In one example, whether to and/or how to construct/use the starting point list may be pre-defined, signalled, derived.
      ii. In one example, block vectors of neighbouring video units (adjacent or non-adjacent) coded with IBC mode or IntraTMP may be used to construct the starting point list.
      iii. In one example, block vectors in IBC HMVP table may be used to construct the starting point list.
      iv. In one example, a syntax element may be signalled to indicate which starting point in the list is applied for IntraTMP.
   b. In one example, the starting point list may be constructed adaptively depending on coding information, such as block size/dimensions.
5. It is proposed to use one or more searching patterns for IntraTMP.
   a. In one example, the searching pattern may be diamond, or square, or cross, or their variants.
   b. In one example, the different searching patterns may be used one by one.
   c. The proposed searching pattern may be used in a two-step (coarse-to-fine) searching strategy.
6. In one example, the cost of a candidate during searching may be modified before being used in comparison with other candidates.
   a. In one example, a scale factor may be used to modify the cost.
      i. In one example, the scale factor may depend on coding information, such as position/location of the candidate.
7. In one example, the block vector of a video unit coded with IntraTMP may be used to update the IBC HMVP table.

### Template Used in IntraTMP

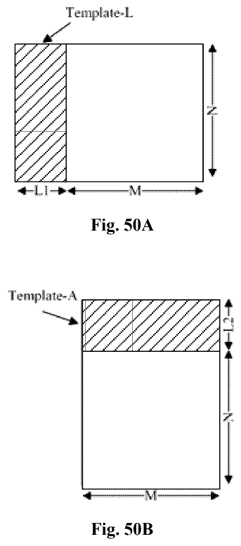

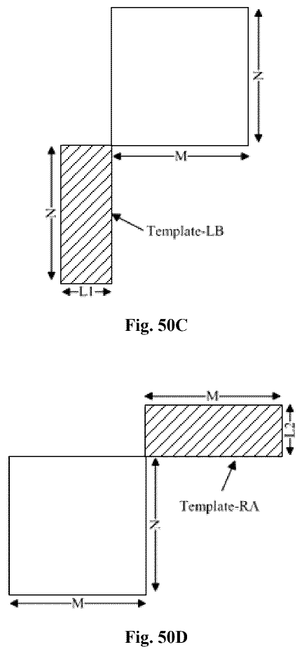

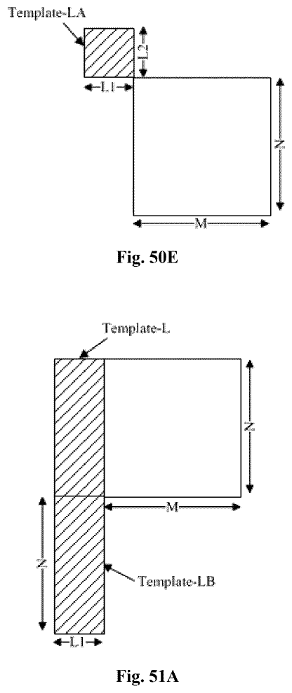

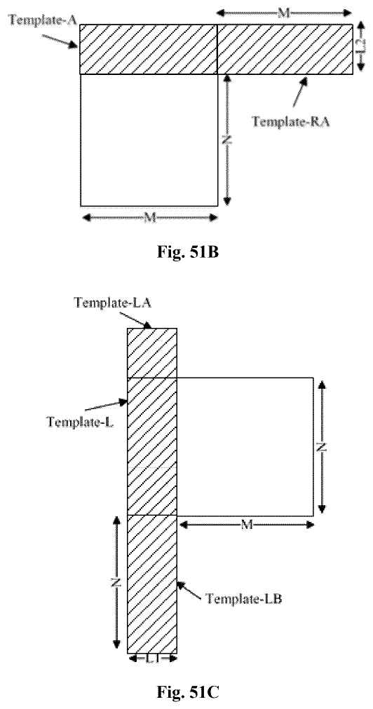

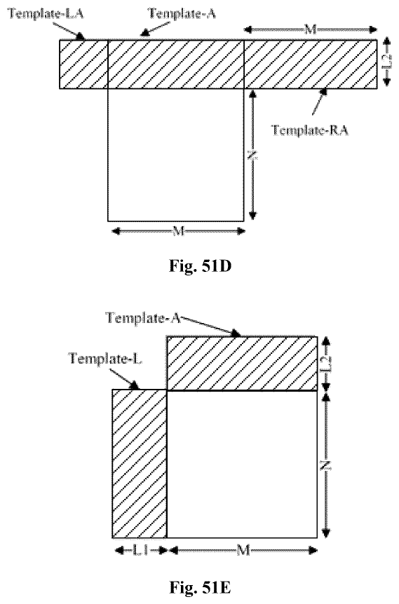

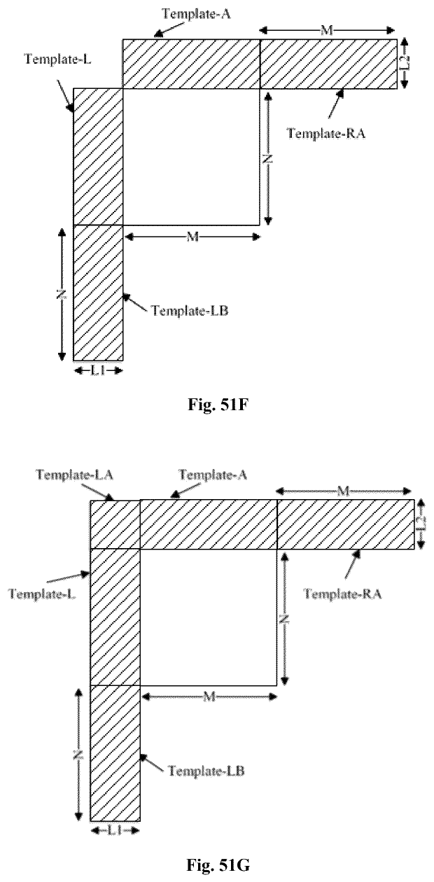

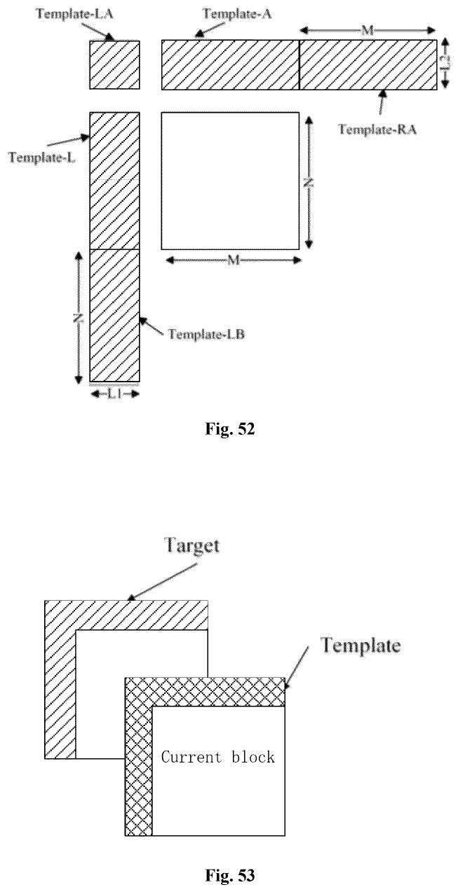

8. Instead of using L-shape as the template in IntraTMP, it is proposed to use multiple templates for IntraTMP.
   a. In one example, one or more templates consisting of the neighbouring (adjacent or non-adjacent) reconstructed samples may be used.
      i. In one example, the template consists of above, or left, or left-above, right-above, left-below reconstructed samples may be used. An example is shown in FIGS. 50A-50E.
      ii. In one example, the combinations of the templates consisting of above, or left, or left-above, right-above, left-below reconstructed samples may be used. An example is shown in FIGS. 51A-51G.
      iii. In one example, non-adjacent templates may be used. An example is shown in FIG. 52.
      iv. In one example, more than one templates may be used.
         1) In one example, which template/templates are used may be pre-defined, signalled, derived.
         2) In one example, the prediction signals generated using different templates may be fused.
   b. In one example, the size of the template may depend on coding information.
      i. In one example, the coding information may refer to block size/dimensions.
         1) In one example, the template width of left, or left-above, or left-below may depend on block width.
         2) In one example, the template height of left, or left-above, or left-below may depend on block height.
         3) In one example, the template width of above, or left-above, or right-above may depend on block width.
         4) In one example, the template height of above, or left-above, or right-above may depend on block height.
9. It is proposed to generate one or more samples to obtain the prediction signal for IntraTMP when the one or more samples are not reconstructed.
   a. In one example, the one or more samples are not reconstructed may refer to there are some overlapped samples between the block pointed by the block vector and the current block. An example is shown in FIG. 53.
   b. In one example, padding method may be used to generate the one or more samples.
      i. In one example, repetitive padding or mirror padding may be used.
   c. In one example, intra prediction/inter prediction/IBC/palette/BDPCM may be used to generate the one or more samples.
   d. Mean-removal SAD (MR-SAD) may be used to derive the cost.

### Multiple Candidates and Fusion

10. In one example, more than one candidate (block vector) may be generated for IntraTMP.
   a. In one example, the more than one candidate may be generated using different templates.
      i. In one example, the different template may refer to different template shape/size.
      ii. In one example, the different template may refer to one or more samples of the template may be modified before being used for searching.
   b. In one example, the more than one candidate may be generated from different regions.
   c. In one example, the more than one candidate may be generated using different searching method, or different thresholds.
   d. In one example, reordering may be used to generate the multiple candidates.
      i. In one example, the same template used for searching may be used in reordering.
      ii. Alternatively, a different template may be used in reordering.
   e. In one example, one or more candidates may be used to generate the prediction signal of the current video unit.
      i. In one example, which one or more candidates are used may be pre-defined, or signalled, or derived.
         1) In one example, one or more syntax elements may be signalled to indicate which one or more candidates are used.
         2) In one example, template based method may be used to derive which one or more candidates are used.
      ii. In one example, more than one candidate may be used to generate the prediction signal of the current video unit.
         1) In one example, the prediction signals generated by the more than one candidate may be fused.
         a) In one example, whether to and/how to fuse the prediction signals (e.g., blending weights) may be pre-defined, or signalled, or derived.
      iii. In one example, the prediction signals generated by one or more candidates may be fused with prediction signals generated by another coding tool except IntraTMP.
         1) In one example, the coding tool may refer to intra prediction, or inter prediction, or IBC, or palette, or BDPCM.
         a) In one example, intra prediction may refer to conventional intra prediction method, Intra TMP, DIMD, TIMD, ISP, MIP, MRL, PDPC/Gradient PDPC, intra prediction fusion, TMRL, cross-component prediction (CCLM), multi-model CCLM, left CCLM, above CCLM, CCCM, left/above CCCM, GLM, DIMD chroma, chroma fusion, or their variants, etc.
         b) In one example, inter prediction may refer to CIIP (e.g., CIIP-Planar, CIIP-TIMD, CIIP-TM), BCW (e.g., BCW index derived by TM), MMVD (e.g., MMVD or TM based reordering for MMVD), template matching (TM), IBC (e.g., IBC-TM, IBC with block vector differences, IBC with reconstruction reordering), affine (e.g., affine-MMVD, TM based reordering for affine MMVD), DMVR/multi-pass DMVR, PROF, BDOF/sample based BDOF, adaptive decoder-side motion vector refinement (ADMVR), OBMC or TM based OBMC, MHP, GPM (e.g., GPM, GPM-TM, GPM-MMVD, GPM-intra), LIC, bilateral/template matching AMVP-merge mode, or their variants, etc.
      iv. In one example, more than one prediction signals may be used to generate the prediction signal of the current video unit.
         1) In one example, a new prediction may be generated by a weighted sum of the more than one prediction signals.
         a) The weighting values may be position-dependent.
11. In one example, one or more filtering method may be used to process the prediction signal of the current video unit for IntraTMP.
   a. In one example, the filtering parameters may be pre-defined, or signalled, or derived.
   b. In one example, PDPC may be used.
   c. In one example, the Least-Mean-Square (LMS) method may be used to derive the filtering parameters.
   d. In one example, the LDL method may be used to derive the filtering parameters.
   e. In one example, the Gaussian elimination may be used to derive the filtering parameters.
   f. In one example, other method that can generate the filtering parameters may be used, such as neural network.
   g. In one example, whether to and/or how to use the filtering method may be pre-defined, or signalled, or derived.

### Fractional Block Vector for IntraTMP

12. It is proposed that fractional block vector may be used for IntraTMP.
   a. In one example, the precision of fractional block vector may be ½^{N}, wherein N is an integer larger than 0.
      i. In one example, N=1, or 2, or 3, or, 4, or 5, or 6.
   b. In one example, multiple precisions of fractional block vector may be used.
      i. In one example, adaptive precisions of fractional block vector may be used.
         1) In one example, the precisions of fractional block vector may depend on coding information, such as resolution of the video, or video content.
         2) In one example, more than one set of precisions of fractional block vector may be used.
         a) In one example, which one set of precisions of fractional block vector may be signalled, or pre-defined, or derived.
   c. In one example, multiple interpolation filters may be used to generate prediction/reconstruction using the fractional block vector.
      i. In one example, M-tap interpolation filter may be used, wherein M is an integer larger than 1.
      ii. In one example, padding method may be used when interpolation is used to generate prediction/reconstruction using the fractional block vector.
         1) In one example, repetitive padding or mirror padding is used.
         2) Alternatively, padding may be not used.
         a) In one example, one or more samples from integer positions may be directly used as the samples of the fractional position.
      iii. Alternatively, one interpolation filter may be used to generate prediction/reconstruction for all precisions of the fractional block vector.
   d. In one example, whether to and/or how to generate the one or more fractional block vector may be pre-defined, or signalled, or derived.
13. In one example, the fractional block vector may be used for the following video units.
   a. In one example, the fractional block vector may be used to construct the IBC AMVP/merge candidate list.
      i. In one example, the fractional block vector is directly used when fractional block vector is used for IBC.
      ii. Alternatively, the fractional block vector is rounded to integer block vector and used.
   b. In one example, the block vector or the fractional block vector may be used to update the HMVP table for IBC.
      i. Alternatively, the rounded block vector of the fractional block vector may be used.
      ii. Alternatively, the fractional block vector may be not used to update the HMVP table for IBC.
   c. In one example, the fractional block vector may be used for other coding tools, such as IntraTMP.
      i. In one example, a block vector candidate list may be constructed for IntraTMP.
         1) In one example, the fractional block vector may be used to construct the candidate list.
      ii. In one example, HMVP table may be used for IntraTMP, and the fractional block vector may be stored in HMVP table for IntraTMP.
   d. In one example, the fractional block vector of luma component may be used for chroma component.
      i. In one example, one or more block vectors at different positions of luma video units may be used.
   e. In one example, when the fractional block vector is used to derive an intra prediction mode, it may be rounded to an integer block vector.

### Block Vector Difference for IntraTMP

14. In one example, one or more offsets may be used to modify the block vector for IntraTMP.
   a. In one example, the one or more offsets may be integer or fractional.
      i. In one example, the fractional block vector difference may be ½^{N}, wherein N is an integer larger than 0.
   b. In one example, the determination of the one or more offsets may be signalled.
      i. In one example, one or more syntax elements may be signalled to indicate which offset is used.
      ii. In one example, more than one set of offsets are used, and one or more syntax elements may be signalled to indicate which set is used.
      iii. In one example, whether to and/how to determine the one or more offsets may depend on coding information, such as block size/dimensions.
      iv. In one example, a reordering process may be used to select M1 offsets from M2 offsets and the M1 offsets are signalled, wherein M1 is less than or equal to M2.
   c. In one example, the determination of the one or more offsets may be derived.
      i. In one example, a reordering process may be used to sort the one or more offsets.
         1) In one example, template matching based method may be used.

### Subblock Based IntraTMP

15. It is proposed that IntraTMP is used to generate the prediction/reconstruction of at least one subblock when the current video unit is divided into more than one subblock.
   a. In one example, the subblocks may be rectangular or square.
      i. In one example, the size of a subblock may be M×N, wherein M=N, or M!=N.
   b. In one example, the subblocks may be divided geometrically.
      i. In one example, partial or all partitioning modes in GPM may be used.
   c. In one example, prediction/reconstruction signals of one or more subblocks may be used in IntraTMP for the following subblocks.
   d. In one example, the template size/shape used for different subblocks may be different.
      i. Alternatively, the template size/shape may be same.
   e. In one example, the template of a sub-block may involve at least one reconstructed sample of another sub-block.
   f. In one example, the template of a sub-block may involve at least one prediction sample of another sub-block.
   g. In one example, the template of a sub-block may only involve reconstructed samples outside of the current block.
   h. In one example, a filtering process or weighting sum process may be used for different subblocks.
      i. In one example, the boundaries of the subblocks may be modified using the prediction/reconstruction samples of other subblocks.
   i. In one example, whether to and/or how to use subblock based IntraTMP may be signalled.
   j. In one example, whether to and/or how to use subblock based IntraTMP may depend on coding information, such as block size/dimensions.
   k. In one example, transform kernel (e.g., LFNST, NSPT, MTS) may be determined for each subblock individually.
      i. Alternatively, a same transform kernel may be used for at least two subblocks.
      ii. In one example, an intra prediction mode derived using the block vector for a subblock may be used for the determination of the transform kernel.

### General Aspects

16. In above examples, the video unit may refer to the video unit may refer to colour component/sub-picture/slice/tile/coding tree unit (CTU)/CTU row/groups of CTU/coding unit (CU)/prediction unit (PU)/transform unit (TU)/coding tree block (CTB)/coding block (CB)/prediction block (PB)/transform block (TB)/a block/sub-block of a block/sub-region within a block/any other region that contains more than one sample or pixel.
17. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.
18. Whether and/or how to apply the above methods may depend on the following information:
   a. A message signalled in the DPS/SPS/VPS/PPS/APS/picture header/slice header/tile group header/Largest coding unit (LCU)/Coding unit (CU)/LCU row/group of LCUs/TU/PU block/Video coding unit.
   b. Position of CU/PU/TU/block/Video coding unit.
   c. Block dimension of current block and/or its neighbouring blocks.
   d. Block shape of current block and/or its neighbouring blocks.
   e. coded mode of a block, e.g., IBC or non-IBC inter mode or non-IBC subblock mode.
   f. Indication of the colour format (such as 4:2:0, 4:4:4).
   g. Coding tree structure.
   h. Slice/tile group type and/or picture type.
   i. Colour component (e.g., may be only applied on chroma components or luma component).
   j. Temporal layer ID.
   k. Profiles/Levels/Tiers of a standard.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one or multiple CTUs/CTBs, one or multiple Virtual Pipeline Data Unit (VPDU), a sub-region within a picture/slice/tile/brick. In the following discussion, IntraTMP may be replaced by other coding tools that rely on coded/decoded/reconstructed information within the same region, e.g., palette, intra block copy (IBC).

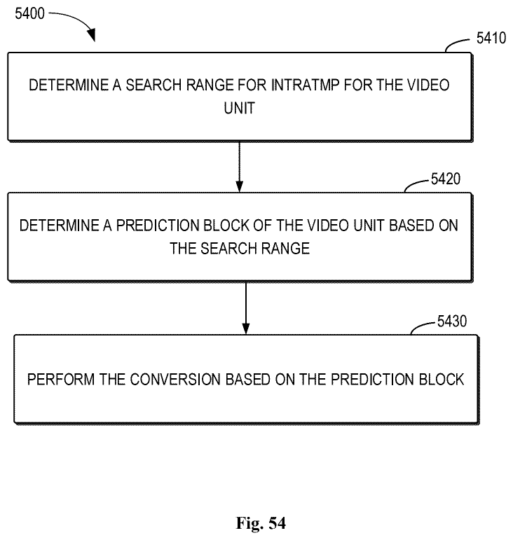

FIG. 54 illustrates a flowchart of a method 5400 for video processing in accordance with embodiments of the present disclosure. The method 5400 is implemented during a conversion between a video unit of a video and a bitstream of the video.

At block 5410, for a conversion between a video unit of a video and a bitstream of the video, it determines a search range for intra template matching prediction (IntraTMP) for a video unit.

At block 5420, a prediction block of the video unit is determined based on the search range. At block 5430, the conversion is performed based on the prediction block. In some embodiments, the conversion includes encoding the video unit into the bitstream. In some embodiments, the conversion includes decoding the video unit from the bitstream. In this way, it can improve coding efficiency and coding performance.

In some embodiments, an adaptive search range is used for IntraTMP. In some embodiments, the search range depends on a video content. In some embodiments, one or more syntax elements are signalled to indicate the determination of the search range.

In some embodiments, the search range depends on coding information. In some embodiments, the search range depends on a resolution or dimensions of the video unit. In some embodiments, the search range depends on resolution or dimensions of picture. In some embodiments, the coding information comprises neighbouring video units or quantization parameter (QP).

In some embodiments, RW=(a1 BW+b1)>>s1 and/or RH=(a2 BH+b2)>>s2, where RW represents a range width, RH represents a range height, BW represents a block width, BH represents a block height, a1, b1, s1 and a2, b2, s2 are integers. In some embodiments, one or more search regions are used for IntraTMP.

In some embodiments, at least one of: location, position, or shape of at least one of a plurality of search regions is adaptive. In some embodiments, one search region is used. In some embodiments, all available areas used for searching belong to one search region.

In some embodiments, the number of search regions depends on coding information. In some embodiments, the coding information comprises at least one of: resolution or dimensions of a current video unit, or resolution or dimensions of neighbouring video units. In some embodiments, a determination of the number of search regions is indicated in the bitstream. In some embodiments, the number of search regions depends on a video content.

In some embodiments, a searching order for different search regions is different. In some embodiments, one or more thresholds are used for early termination in a searching process of IntraTMP. In some embodiments, one or more thresholds are used to stop searching for IntraTMP.

In some embodiments, the searching process is terminated, if a cost is smaller or no greater than a threshold. In some embodiments, the one or more thresholds are different for coarse searching and refinement searching. In some embodiments, the one or more thresholds depend on coding information. In some embodiments, the coding information comprises at least one of: template size, template dimensions, block size, block dimensions, QP or a sum of absolute differences (SAD).

In some embodiments, the one or more thresholds are used in coarse searching. In some embodiments, the one or more thresholds are used in refinement searching.

In some embodiments, a determination of the one or more thresholds is pre-defined, or wherein the determination of the one or more thresholds is indicated. Alternatively, the determination of the one or more thresholds is derived. In some embodiments, a predictive searching is used for IntraTMP, where one or more starting points are used for searching.

In some embodiments, a starting point list is constructed, and one or more of starting points in the starting point list are used for searching. In some embodiments, whether to and/or how to construct the starting point list is pre-defined. Alternatively, whether to and/or how to construct the starting point list is indicated. Alternatively, whether to and/or how to construct the starting point list is derived.

In some embodiments, whether to and/or how to use the starting point list is pre-defined. Alternatively, whether to and/or how to use the starting point list is indicated. Alternatively, whether to and/or how to use the starting point list is derived.

In some embodiments, block vectors of neighbouring video units coded with intra block copy (IBC) mode or IntraTMP is used to construct the starting point list. In some embodiments, block vectors in IBC history-based motion vector prediction (HMVP) table is used to construct the starting point list.

In some embodiments, a syntax element is signalled to indicate which starting point in the starting point list is applied to IntraTMP. In some embodiments, the starting point list is constructed adaptively depending on coding information.

In some embodiments, one or more searching patterns is used for IntraTMP. In some embodiments, the one or more searching pattern are diamond, or square, or cross, or a variant of diamond, or a variant of square, or a variant of cross. In some embodiments, different searching patterns is used one by one. In some embodiments, a searching pattern is used in a two-step searching strategy.

In some embodiments, a cost of a candidate during searching is modified before being used in comparison with other candidates. In some embodiments, a scale factor is used to modify the cost. In some embodiments, the scale factor depends on coding information. In some embodiments, the coding information comprises a position or location of the candidate.

In some embodiments, a block vector of the video unit coded with IntraTMP is used to update an IBC HMVP table. In some embodiments, a plurality of templates is used for IntraTMP.

In some embodiments, one or more templates including neighbouring reconstructed samples are used. In some embodiments, a template including at least one of: above reconstructed samples, left reconstructed samples, left-above reconstructed samples, right-above reconstructed samples, or left-below reconstructed samples is used. In some embodiments, a combination of the one or more templates including at least one of: above reconstructed samples, left reconstructed samples, left-above reconstructed samples, right-above reconstructed samples, or left-below reconstructed samples is used. In some embodiments, non-adjacent templates are used. In some embodiments, more than one templates are used.

In some embodiments, which template is used is pre-defined. Alternatively, which template is used is signaled. Alternatively, which template is used is derived.

In some embodiments, prediction signals generated using different templates are combined. In some embodiments, a size of a template depends on coding information. In some embodiments, the coding information comprises block size or block dimensions.

In some embodiments, a template width of left, or left-above, or left-below depends on block width. In some embodiments, a template height of left, or left-above, or left-below depends on block height. In some embodiments, a template width of above, or left-above, or right-above depends on block width. In some embodiments, a template height of above, or left-above, or right-above depends on block height.

In some embodiments, one or more samples are generated to obtain a prediction signal for IntraTMP, if the one or more samples are not reconstructed. In some embodiments, a padding method is used to generate the one or more samples. In some embodiments, a repetitive padding or a mirror padding is used. In some embodiments, the one or more samples are not reconstructed comprise some overlapped samples between a block pointed by a block vector and a current block.

In some embodiments, at least one of: intra prediction, inter prediction, IBC, palette, or block-based differential pulse-code modulation (BDPCM) is used to generate the one or more samples. In some embodiments, a mean-removal SAD (MR-SAD) is used to derive the cost.

In some embodiments, more than one candidate is generated for IntraTMP. In some embodiments, the more than one candidate is generated using different templates.

In some embodiments, the different templates have different shapes or different sizes. In some embodiments, the different templates comprise one or more samples of the template is modified before being used for searching.

In some embodiments, the more than one candidate is generated from different regions. In some embodiments, the more than one candidate is generated using different searching method, or different thresholds.

In some embodiments, a reordering is used to generate the more than one candidate. In some embodiments, a same template used for searching is used in reordering. In some embodiments, a different template is used in reordering.

In some embodiments, one or more candidates is used to generate the prediction signal of the current video unit. In some embodiments, which one or more candidates are used is pre-defined. Alternatively, which one or more candidates are used is signalled. Alternatively, which one or more candidates are used is derived.

In some embodiments, one or more syntax elements are signalled to indicate which one or more candidates are used. In some embodiments, a template based method is used to derive which one or more candidates are used. In some embodiments, more than one candidate is used to generate a prediction signal of a current video unit.

In some embodiments, the prediction signals generated by the more than one candidate are combined. In some embodiments, whether to and/how to combine the prediction signals is pre-defined. Alternatively, whether to and/how to combine the prediction signals is signalled. Alternatively, whether to and/how to combine the prediction signals is derived.

In some embodiments, the prediction signals generated by one or more candidates is combined with prediction signals generated by another coding tool except IntraTMP. In some embodiments, the other coding tool comprises one of: intra prediction, or inter prediction, or IBC, or palette, or BDPCM. In some embodiments, the intra prediction comprises one of: a conventional intra prediction method, Intra TMP, decoder-side intra mode derivation (DIMD), template-based intra mode derivation (TIMD), intra sub-partition (ISP), matrix weighted intra prediction (MIP), multiple reference line intra prediction (MRL), position dependent intra prediction combination (PDPC), Gradient PDPC, intra prediction fusion, TMRL, cross-component prediction (CCLM), multi-model CCLM, left CCLM, above CCLM, convolutional cross-component model (CCCM), left CCCM, above CCCM, gradient linear model (GLM), DIMD chroma, chroma fusion, or their variants. In some embodiments, the inter prediction comprises one of: combined inter and intra prediction (CIIP), bi-prediction with CU-level weight (BCW), merge mode with motion vector difference (MMVD), template matching (TM), IBC, affine, decoder side motion vector refinement (DMVR), multi-pass DMVR, prediction refinement with optical flow (PROF), bi-directional optical flow (BDOF), sample based BDOF, adaptive decoder-side motion vector refinement (ADMVR), overlapped block motion compensation (OBMC), TM based OBMC, multi-hypothesis prediction (MHP), geometric portioning mode (GPM), local illumination compensation (LIC), bilateral/template matching advanced motion vector prediction (AMVP)-merge mode, or their variants.

In some embodiments, more than one prediction signals are used to generate a prediction signal of a current video unit. In some embodiments, a new prediction is generated by a weighted sum of the more than one prediction signals. In some embodiments, weighting values is position-dependent.

In some embodiments, one or more filtering method are used to process a prediction signal of the video unit for IntraTMP. In some embodiments, one or more filtering parameters are pre-defined. Alternatively, one or more filtering parameters are signalled. Alternatively, one or more filtering parameters are derived.

In some embodiments, PDPC is used. In some embodiments, a Least-Mean-Square (LMS) method is used to derive one or more filtering parameters. In some embodiments, an LDL method is used to derive one or more filtering parameters. In some embodiments, a Gaussian elimination is used to derive one or more filtering parameters.

In some embodiments, other method that is able to generate one or more filtering parameters is used. In some embodiments, the other method comprises a neural network.

In some embodiments, whether to and/or how to use the filtering method is pre-defined. Alternatively, whether to and/or how to use the filtering method is signalled, or wherein whether to and/or how to use the filtering method is derived.

In some embodiments, a fractional block vector is used for IntraTMP. In some embodiments, a precision of the fractional block vector is ½^{N}, where N is an integer larger than 0. In some embodiments, N=1, or 2, or 3, or, 4, or 5, or 6. In some embodiments, a plurality of precisions of fractional block vector is used.

In some embodiments, adaptive precisions of fractional block vector are used. In some embodiments, precisions of fractional block vector depend on coding information.

In some embodiments, more than one set of precisions of fractional block vector is used. In some embodiments, which one set of precisions of fractional block vector is signalled. Alternatively, which one set of precisions of fractional block vector is pre-defined. Alternatively, which one set of precisions of fractional block vector is derived.

In some embodiments, a plurality of interpolation filters is used to generate prediction or reconstruction using the fractional block vector. In some embodiments, M-tap interpolation filter is used, where M is an integer larger than 1.

In some embodiments, a padding method is used, if the interpolation filter is used to generate prediction or reconstruction using the fractional block vector. In some embodiments, a repetitive padding or a mirror padding is used. In some embodiments, a padding is not used.

In some embodiments, one or more samples from integer positions are directly used as samples of a fractional position. In some embodiments, one interpolation filter is used to generate prediction or reconstruction for all precisions of the fractional block vector. In some embodiments, whether to and/or how to generate the one or more fractional block vector is pre-defined. Alternatively, whether to and/or how to generate the one or more fractional block vector is signalled. Alternatively, whether to and/or how to generate the one or more fractional block vector is derived.

In some embodiments, the fractional block vector is used for one or more video units. In some embodiments, the fractional block vector is used to construct at least one of: an IBC advanced motion vector prediction (AMVP) candidate list, or an IBC merge candidate list. In some embodiments, the fractional block vector is directly used, if the fractional block vector is used for IBC or IntraTMP. In some embodiments, the fractional block vector is rounded to integer block vector and used. In some embodiments, the fractional block vector is used to update a history based motion vector prediction (HMVP) table for IBC.

In some embodiments, a rounded block vector of the fractional block vector is used. In some embodiments, the fractional block vector is not used to update the HMVP table for IBC.

In some embodiments, the fractional block vector is used for other coding tool. In some embodiments, the other coding tool comprises IntraTMP.

In some embodiments, a block vector candidate list is constructed for IntraTMP. In some embodiments, the fractional block vector is used to construct the block vector candidate list. In some embodiments, a HMVP table is used for IntraTMP, and the fractional block vector is stored in the HMVP table for IntraTMP.

In some embodiments, a fractional block vector of luma component is used for chroma component. In some embodiments, one or more block vectors at different positions of luma video units are used.

In some embodiments, if the fractional block vector is used to derive an intra prediction mode, the fractional block vector is rounded to an integer block vector. In some embodiments, one or more offsets are used to modify a block vector for IntraTMP. In some embodiments, the one or more offsets are integer or fractional.

In some embodiments, a fractional block vector difference is ½^{N}, where N is an integer larger than 0. In some embodiments, a determination of the one or more offsets is signalled. In some embodiments, one or more syntax elements are signalled to indicate which offset is used. In some embodiments, more than one set of offsets are used, and one or more syntax elements are signalled to indicate which set is used. In some embodiments, whether to and/how to determine the one or more offsets depend on coding information.

In some embodiments, a reordering process is used to select M1 offsets from M2 offsets and the M1 offsets are signalled, wherein M1 is less than or equal to M2. In some embodiments, the determination of the one or more offsets is derived. In some embodiments, a reordering process is used to sort the one or more offsets. In some embodiments, a template matching based method is used. In some embodiments, IntraTMP is used to generate a prediction or reconstruction of at least one subblock, if the video unit is divided into a plurality of subblocks. In some embodiments, the plurality of subblocks is rectangular or square. In some embodiments, a size of a subblock is M N, where M is equal to N, or M is not equal to N.

In some embodiments, the plurality of subblocks is divided geometrically. In some embodiments, partial or all partitioning modes in GPM is used. In some embodiments, prediction signals or reconstruction signals of one or more subblocks is used. In some embodiments, template sizes or shapes used for different subblocks are different. In some embodiments, the template size or shape is same.

In some embodiments, a template of a sub-block involves at least one reconstructed sample of another sub-block. In some embodiments, a template of a sub-block involves at least one prediction sample of another sub-block. In some embodiments, a template of a sub-block involve reconstructed samples outside of the current block.

In some embodiments, a filtering process or weighting sum process is used for different subblocks. In some embodiments, boundaries of the subblocks is modified using the prediction or/reconstruction samples of other subblocks.

In some embodiments, whether to and/or how to use subblock based IntraTMP is signalled. In some embodiments, whether to and/or how to use subblock based IntraTMP depends on coding information.

In some embodiments, a transform kernel is determined for each subblock individually. In some embodiments, a same transform kernel is used for at least two subblocks. In some embodiments, an intra prediction mode derived using a block vector for a subblock is used for a determination of a transform kernel.

In some embodiments, the video unit comprises at least one of: a color component, a prediction block (PB), a transform block (TB), a coding block (CB), a prediction unit (PU), a transform unit (TU), a coding tree block (CTB), a coding unit (CU), a coding tree unit (CTU), a CTU row, groups of CTU, a slice, a tile, a sub-picture, a block, a sub-region within a block, or a region containing more than one sample or pixel. In some embodiments, an indication of whether to and/or how to determine the search range for IntraTMP is indicated at one of the followings: sequence level, group of pictures level, picture level, slice level, or tile group level. In some embodiments, an indication of whether to and/or how to determine the search range for IntraTMP is indicated in one of the following: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header.

In some embodiments, the method 5400 further comprises: determining whether to and/or how to determine the search range for IntraTMP based on at least one of the followings: a message indicated in one of: DPS, SPS, VPS, PPS, APS, picture header, slice header, tile group header, largest coding unit (LCU), coding unit (CU), LCU row, group of LCUs, TU, PU block, video coding unit, a position of one of: CU, PU, TU, block, video coding unit, a block dimension of current block and/or its neighbouring blocks, a block shape of current block and/or its neighbouring blocks, a coded mode of the video unit, an indication of colour format, a coding tree structure a slice type, a tile group type, a picture type, a colour component, a temporal layer identity, profiles or levels or Tiers of a standard.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a search range for intra template matching prediction (IntraTMP) for a video unit of the video; determining a prediction block of the video unit based on the search range; and generating the bitstream based on the prediction block.

According to still further embodiments of the present disclosure, a method for storing bitstream of a video is provided. The method comprises: determining a search range for intra template matching prediction (IntraTMP) for a video unit of the video; determining a prediction block of the video unit based on the search range; generating the bitstream based on the prediction block; and storing the bitstream in a non-transitory computer-readable recording medium.

Implementations of the present disclosure can be described in view of the following clauses, the features of which can be combined in any reasonable manner.

Clause 1. A method of video processing, comprising: determining, for a conversion between a video unit of a video and a bitstream of the video, a search range for intra template matching prediction (IntraTMP) for a video unit; determining a prediction block of the video unit based on the search range; and performing the conversion based on the prediction block.

Clause 2. The method of clause 1, wherein an adaptive search range is used for IntraTMP.

Clause 3. The method of clause 1, wherein the search range depends on a video content.

Clause 4. The method of clause 1, wherein one or more syntax elements are signalled to indicate the determination of the search range.

Clause 5. The method of clause 1, wherein the search range depends on coding information.

Clause 6. The method of clause 5, wherein the search range depends on a resolution or dimensions of the video unit.

Clause 7. The method of clause 6, wherein the search range depends on resolution or dimensions of picture.

Clause 8. The method of clause 5, wherein the coding information comprises neighbouring video units or quantization parameter (QP).

Clause 9. The method of clause 1, wherein RW=(a1 BW+b1)>>s1 and/or RH=(a2 BH+b2)>>s2, wherein RW represents a range width, RH represents a range height, BW represents a block width, BH represents a block height, a1, b1, s1 and a2, b2, s2 are integers.

Clause 10. The method of clause 1, wherein one or more search regions are used for IntraTMP.

Clause 11. The method of clause 10, wherein at least one of: location, position, or shape of at least one of a plurality of search regions is adaptive.

Clause 12. The method of clause 19, wherein one search region is used.

Clause 13. The method of clause 12, wherein all available areas used for searching belong to one search region.

Clause 14. The method of clause 10, the number of search regions depends on coding information.

Clause 15. The method of clause 14, the coding information comprises at least one of: resolution or dimensions of a current video unit, or resolution or dimensions of neighbouring video units.

Clause 16. The method of clause 10, wherein a determination of the number of sarch regions is indicated in the bitstream.

Clause 17. The method of clause 10, wherein the number of search regions depends on a video content.

Clause 18. The method of clause 10, wherein a searching order for different search regions is different.

Clause 19. The method of clause 1, wherein one or more thresholds are used for early termination in a searching process of IntraTMP.

Clause 20. The method of clause 19, wherein one or more thresholds are used to stop searching for IntraTMP.

Clause 21. The method of clause 20, wherein the searching process is terminated, if a cost is smaller or no greater than a threshold.

Clause 22. The method of clause 19, wherein the one or more thresholds are different for coarse searching and refinement searching.

Clause 23. The method of clause 19, wherein the one or more thresholds depend on coding information.

Clause 24. The method of clause 23, wherein the coding information comprises at least one of: template size, template dimensions, block size, block dimensions, QP or a sum of absolute differences (SAD).

Clause 25. The method of clause 19, wherein the one or more thresholds are used in coarse searching.

Clause 26. The method of clause 19, wherein the one or more thresholds are used in refinement searching.

Clause 27. The method of clause 19, wherein a determination of the one or more thresholds is pre-defined, or wherein the determination of the one or more thresholds is indicated, or wherein the determination of the one or more thresholds is derived.

Clause 28. The method of clause 1. wherein a predictive searching is used for IntraTMP, wherein one or more starting points are used for searching.

Clause 29. The method of clause 28, wherein a starting point list is constructed, and one or more of starting points in the starting point list are used for searching.

Clause 30. The method of clause 29, wherein whether to and/or how to construct the starting point list is pre-defined, wherein whether to and/or how to construct the starting point list is indicated, or whether to and/or how to construct the starting point list is derived.

Clause 31. The method of clause 29, wherein whether to and/or how to use the starting point list is pre-defined, wherein whether to and/or how to use the starting point list is indicated, or whether to and/or how to use the starting point list is derived.

Clause 32. The method of clause 29, wherein block vectors of neighbouring video units coded with intra block copy (IBC) mode or IntraTMP is used to construct the starting point list.

Clause 33. The method of clause 29, wherein block vectors in IBC history-based motion vector prediction (HMVP) table is used to construct the starting point list.

Clause 34. The method of clause 29, wherein a syntax element is signalled to indicate which starting point in the starting point list is applied to IntraTMP.

Clause 35. The method of clause 29, wherein the starting point list is constructed adaptively depending on coding information.

Clause 36. The method of clause 1, wherein one or more searching patterns is used for IntraTMP.

Clause 37. The method of clause 36, wherein the one or more searching pattern are diamond, or square, or cross, or a variant of diamond, or a variant of square, or a variant of cross.

Clause 38. The method of clause 36, wherein different searching patterns is used one by one.

Clause 39. The method of clause 36, wherein a searching pattern is used in a two-step searching strategy.

Clause 40. The method of clause 1, wherein a cost of a candidate during searching is modified before being used in comparison with other candidates.

Clause 41. The method of clause 40, wherein a scale factor is used to modify the cost.

Clause 42. The method of clause 41, wherein the scale factor depends on coding information.

Clause 43. The method of clause 42, wherein the coding information comprises a position or location of the candidate.

Clause 44. The method of clause 1, wherein a block vector of the video unit coded with IntraTMP is used to update an IBC HMVP table.

Clause 45. The method of clause 1, wherein a plurality of templates is used for IntraTMP.

Clause 46. The method of clause 45, wherein one or more templates including neighbouring reconstructed samples are used.

Clause 47. The method of clause 46, wherein a template including at least one of: above reconstructed samples, left reconstructed samples, left-above reconstructed samples, right-above reconstructed samples, or left-below reconstructed samples is used.

Clause 48. The method of clause 46, wherein a combination of the one or more templates including at least one of: above reconstructed samples, left reconstructed samples, left-above reconstructed samples, right-above reconstructed samples, or left-below reconstructed samples is used.

Clause 49. The method of clause 46, wherein non-adjacent templates are used.

Clause 50. The method of clause 46, wherein more than one templates are used.

Clause 51. The method of clause 50, wherein which template is used is pre-defined, or wherein which template is used is signaled, or wherein which template is used is derived.

Clause 52. The method of clause 50, wherein prediction signals generated using different templates are combined.

Clause 53. The method of clause 45, wherein a size of a template depends on coding information.

Clause 54. The method of clause 53, wherein the coding information comprises block size or block dimensions.

Clause 55. The method of clause 54, wherein a template width of left, or left-above, or left-below depends on block width.

Clause 56. The method of clause 54, wherein a template height of left, or left-above, or left-below depends on block height.

Clause 57. The method of clause 54, wherein a template width of above, or left-above, or right-above depends on block width.

Clause 58. The method of clause 54, wherein a template height of above, or left-above, or right-above depends on block height.

Clause 59. The method of clause 1, wherein one or more samples are generated to obtain a prediction signal for IntraTMP, if the one or more samples are not reconstructed.

Clause 60. The method of clause 59, wherein a padding method is used to generate the one or more samples.

Clause 61. The method of clause 60, wherein a repetitive padding or a mirror padding is used.

Clause 62. The method of clause 59, wherein the one or more samples are not reconstructed comprise some overlapped samples between a block pointed by a block vector and a current block.

Clause 63. The method of clause 59, wherein at least one of: intra prediction, inter prediction, IBC, palette, or block-based differential pulse-code modulation (BDPCM) is used to generate the one or more samples.

Clause 64. The method of clause 59, wherein a mean-removal SAD (MR-SAD) is used to derive the cost.

Clause 65. The method of clause 1, wherein more than one candidate is generated for IntraTMP.

Clause 66. The method of clause 65, wherein the more than one candidate is generated using different templates.

Clause 67. The method of clause 66, wherein the different templates have different shapes or different sizes.

Clause 68. The method of clause 66, wherein the different templates comprise one or more samples of the template is modified before being used for searching.

Clause 69. The method of clause 65, wherein the more than one candidate is generated from different regions.

Clause 70. The method of clause 65, wherein the more than one candidate is generated using different searching method, or different thresholds.

Clause 71. The method of clause 65, wherein a reordering is used to generate the more than one candidate.

Clause 72. The method of clause 71, wherien a same template used for searching is used in reordering.

Clause 73. The method of clause 71, wherein a different template is used in reordering.

Clause 74. The method of clause 65, wherein one or more candidates is used to generate the prediction signal of the current video unit.

Clause 75. The method of clause 74, wherein which one or more candidates are used is pre-defined, or wherein which one or more candidates are used is signalled, or wherein which one or more candidates are used is derived.

Clause 76. The method of clause 75, wherein one or more syntax elements are signalled to indicate which one or more candidates are used.

Clause 77. The method of clause 75, wherein a template based method is used to derive which one or more candidates are used.

Clause 78. The method of clause 74, wherein more than one candidate is used to generate a prediction signal of a current video unit.

Clause 79. The method of clause 78, wherein the prediction signals generated by the more than one candidate are combined.

Clause 80. The method of clause 79, wherein whether to and/how to combine the prediction signals is pre-defined, or wherein whether to and/how to combine the prediction signals is signalled, or wherein whether to and/how to combine the prediction signals is derived.

Clause 81. The method of clause 74, wherein the prediction signals generated by one or more candidates is combined with prediction signals generated by another coding tool except IntraTMP.

Clause 82. The method of clause 81, wherein the other coding tool comprises one of: intra prediction, or inter prediction, or IBC, or palette, or BDPCM.

Clause 83. The method of clause 82, wherein the intra prediction comprises one of: a conventional intra prediction method, Intra TMP, decoder-side intra mode derivation (DIMD), template-based intra mode derivation (TIMD), intra sub-partition (ISP), matrix weighted intra prediction (MIP), multiple reference line intra prediction (MRL), position dependent intra prediction combination (PDPC), Gradient PDPC, intra prediction fusion, TMRL, cross-component prediction (CCLM), multi-model CCLM, left CCLM, above CCLM, convolutional cross-component model (CCCM), left CCCM, above CCCM, gradient linear model (GLM), DIMD chroma, chroma fusion, or their variants.

Clause 84. The method of clause 82, wherein the inter prediction comprises one of: combined inter and intra prediction (CIIP), bi-prediction with CU-level weight (BCW), merge mode with motion vector difference (MMVD), template matching (TM), IBC, affine, decoder side motion vector refinement (DMVR), multi-pass DMVR, prediction refinement with optical flow (PROF), bi-directional optical flow (BDOF), sample based BDOF, adaptive decoder-side motion vector refinement (ADMVR), overlapped block motion compensation (OBMC), TM based OBMC, multi-hypothesis prediction (MHP), geometric portioning mode (GPM), local illumination compensation (LIC), bilateral/template matching advanced motion vector prediction (AMVP)-merge mode, or their variants.

Clause 85. The method of clause 74, wherein more than one prediction signals are used to generate a prediction signal of a current video unit.

Clause 86. The method of clause 85, wherein a new prediction is generated by a weighted sum of the more than one prediction signals.

Clause 87. The method of clause 86, wherein weighting values is position-dependent.

Clause 88. The method of clause 1, wherein one or more filtering method are used to process a prediction signal of the video unit for IntraTMP.

Clause 89. The method of clause 88, wherein one or more filtering parameters are pre-defined, or wherein one or more filtering parameters are signalled, or wherein one or more filtering parameters are derived.

Clause 90. The method of clause 88, wherein PDPC is used.

Clause 91. The method of clause 88, wherein a Least-Mean-Square (LMS) method is used to derive one or more filtering parameters.

Clause 92. The method of clause 88, wherein an LDL method is used to derive one or more filtering parameters.

Clause 93. The method of clause 88, wherien a Gaussian elimination is used to derive one or more filtering parameters.

Clause 94. The method of clause 88, wherein other method that is able to generate one or more filtering parameters is used.

Clause 95. The method of clause 94, wherein the other method comprises a neural network.

Clause 96. The method of clause 88, wherein whether to and/or how to use the filtering method is pre-defined, or wherein whether to and/or how to use the filtering method is signalled, or wherein whether to and/or how to use the filtering method is derived.

Clause 97. The method of clause 1, wherein a fractional block vector is used for IntraTMP.

Clause 98. The method of clause 97, wherein a precision of the fractional block vector is ½^{N}, wherein N is an integer larger than 0.

Clause 99. The method of clause 98, wherein N=1, or 2, or 3, or, 4, or 5, or 6.

Clause 100. The method of clause 97, wherein a plurality of precisions of fractional block vector is used.

Clause 101. The method of clause 97, wherein adaptive precisions of fractional block vector are used.

Clause 102. The method of clause 101, wherein precisions of fractional block vector depend on coding information.

Clause 103. The method of clause 101, wherein more than one set of precisions of fractional block vector is used.

Clause 104. The method of clause 101, wherein which one set of precisions of fractional block vector is signalled, or wherein which one set of precisions of fractional block vector is pre-defined, or wherein which one set of precisions of fractional block vector is derived.

Clause 105. The method of clause 97, wherein a plurality of interpolation filters is used to generate prediction or reconstruction using the fractional block vector.

Clause 106. The method of clause 105, wherein M-tap interpolation filter is used, wherein M is an integer larger than 1.

Clause 107. The method of clause 105, wherein a padding method is used, if the interpolation filter is used to generate prediction or reconstruction using the fractional block vector.

Clause 108. The method of clause 107, wherein a repetitive padding or a mirror padding is used.

Clause 109. The method of clause 107, wherein a padding is not used.

Clause 110. The method of clause 109, wherein one or more samples from integer positions are directly used as samples of a fractional position.

Clause 111. The method of clause 105, wherein one interpolation filter is used to generate prediction or reconstruction for all precisions of the fractional block vector.

Clause 112. The method of clause 97, wherein whether to and/or how to generate the one or more fractional block vector is pre-defined, or wherein whether to and/or how to generate the one or more fractional block vector is signalled, or wherein whether to and/or how to generate the one or more fractional block vector is derived.

Clause 113. The method of clause 1, wherein the fractional block vector is used for one or more video units.

Clause 114. The method of clause 113, wherein the fractional block vector is used to construct at least one of: an IBC advanced motion vector prediction (AMVP) candidate list, or an IBC merge candidate list.

Clause 115. The method of clause 114, wherein the fractional block vector is directly used, if the fractional block vector is used for IBC or IntraTMP.

Clause 116. The method of clause 113, wherein the fractional block vector is rounded to integer block vector and used.

Clause 117. The method of clause 113, wherein the fractional block vector is used to update a history based motion vector prediction (HMVP) table for IBC.

Clause 118. The method of clause 113, wherein a rounded block vector of the fractional block vector is used.

Clause 119. The method of clause 113, wherein the fractional block vector is not used to update the HMVP table for IBC.

Clause 120. The method of clause 113, wherein the fractional block vector is used for other coding tool.

Clause 121. The method of clause 120, wherein the other coding tool comprises IntraTMP.

Clause 122. The method of clause 113, wherein a block vector candidate list is constructed for IntraTMP.

Clause 123. The method of clause 122, wherein the fractional block vector is used to construct the block vector candidate list.

Clause 124. The method of clause 113, wherein a HMVP table is used for IntraTMP, and the fractional block vector is stored in the HMVP table for IntraTMP.

Clause 125. The method of clause 113, wherein a fractional block vector of luma component is used for chroma component.

Clause 126. The method of clause 113, wherein one or more block vectors at different positions of luma video units are used.

Clause 127. The method of clause 113, wherein if the fractional block vector is used to derive an intra prediction mode, the fractional block vector is rounded to an integer block vector.

Clause 128. The method of clause 1, wherein one or more offsets are used to modify a block vector for IntraTMP.

Clause 129. The method of clause 128, wherein the one or more offsets are integer or fractional.

Clause 130. The method of clause 129, wherein a fractional block vector difference is ½^{N}, wherein N is an integer larger than 0.

Clause 131. The method of clause 128, wherein a determination of the one or more offsets is signalled.

Clause 132. The method of clause 131, wherein one or more syntax elements are signalled to indicate which offset is used.

Clause 133. The method of clause 131, wherein more than one set of offsets are used, and one or more syntax elements are signalled to indicate which set is used.

Clause 134. The method of clause 131, wherein whether to and/how to determine the one or more offsets depend on coding information.

Clause 135. The method of clause 131, wherein a reordering process is used to select M1 offsets from M2 offsets and the M1 offsets are signalled, wherein M1 is less than or equal to M2.

Clause 136. The method of clause 128, wherein the determination of the one or more offsets is derived.

Clause 137. The method of clause 136, wherein a reordering process is used to sort the one or more offsets.

Clause 138. The method of clause 137, wherein a template matching based method is used.

Clause 139. The method of clause 1, wherein IntraTMP is used to generate a prediction or reconstruction of at least one subblock, if the video unit is divided into a plurality of subblocks.

Clause 140. The method of clause 139, wherein the plurality of subblocks is rectangular or square.

Clause 141. The method of clause 140, wherein a size of a subblock is M N, wherein M is equal to N, or M is not equal to N.

Clause 142. The method of clause 139, wherein the plurality of subblocks is divided geometrically.

Clause 143. The method of clause 142, wherein partial or all partitioning modes in GPM is used.

Clause 144. The method of clause 139, wherein prediction signals or reconstruction signals of one or more subblocks is used.

Clause 145. The method of clause 139, wherein template sizes or shapes used for different subblocks are different.

Clause 146. The method of clause 139, wherein the template size or shape is same.

Clause 147. The method of clause 139, wherein a template of a sub-block involves at least one reconstructed sample of another sub-block.

Clause 148. The method of clause 139, wherein a template of a sub-block involves at least one prediction sample of another sub-block.

Clause 149. The method of clause 139, wherein a template of a sub-block involve reconstructed samples outside of the current block.

Clause 150. The method of clause 139, wherein a filtering process or weighting sum process is used for different subblocks.

Clause 151. The method of clause 150, wherein boundaries of the subblocks is modified using the prediction or/reconstruction samples of other subblocks.

Clause 152. The method of clause 139, wherein whether to and/or how to use subblock based IntraTMP is signalled.

Clause 153. The method of clause 139, wherein whether to and/or how to use subblock based IntraTMP depends on coding information.

Clause 154. The method of clause 139, wherein a transform kernel is determined for each subblock individually.

Clause 155. The method of clause 139, wherein a same transform kernel is used for at least two subblocks.

Clause 156. The method of clause 139, wherein an intra prediction mode derived using a block vector for a subblock is used for a determination of a transform kernel.

Clause 157. The method of any of clauses 1-156, wherein the video unit comprises at least one of: a color component, a prediction block (PB), a transform block (TB), a coding block (CB), a prediction unit (PU), a transform unit (TU), a coding tree block (CTB), a coding unit (CU), a coding tree unit (CTU), a CTU row, groups of CTU, a slice, a tile, a sub-picture, a block, a sub-region within a block, or a region containing more than one sample or pixel.

Clause 158. The method of any of clauses 1-157, wherein an indication of whether to and/or how to determine the search range for IntraTMP is indicated at one of the followings: sequence level, group of pictures level, picture level, slice level, or tile group level.

Clause 159. The method of any of clauses 1-157, wherein an indication of whether to and/or how to determine the search range for IntraTMP is indicated in one of the following: a sequence header, a picture header, a sequence parameter set (SPS), a video parameter set (VPS), a decoding parameter set (DPS), a decoding capability information (DCI), a picture parameter set (PPS), an adaptation parameter sets (APS), a slice header, or a tile group header.

Clause 160. The method of any of clauses 1-157, further comprising: determining whether to and/or how to determine the search range for IntraTMP based on at least one of the followings: a message indicated in one of: DPS, SPS, VPS, PPS, APS, picture header, slice header, tile group header, largest coding unit (LCU), coding unit (CU), LCU row, group of LCUs, TU, PU block, video coding unit, a position of one of: CU, PU, TU, block, video coding unit, a block dimension of current block and/or its neighbouring blocks, a block shape of current block and/or its neighbouring blocks, a coded mode of the video unit, an indication of colour format, a coding tree structure a slice type, a tile group type, a picture type, a colour component, a temporal layer identity, profiles or levels or Tiers of a standard.

Clause 161. The method of any of clauses 1-160, wherein the conversion includes encoding the video unit into the bitstream.

Clause 162. The method of any of clauses 1-160, wherein the conversion includes decoding the video unit from the bitstream.

Clause 163. An apparatus for video processing comprising a processor and a non-transitory memory with instructions thereon, wherein the instructions upon execution by the processor, cause the processor to perform a method in accordance with any of clauses 1-162.

Clause 164. A non-transitory computer-readable storage medium storing instructions that cause a processor to perform a method in accordance with any of clauses 1-162.

Clause 165. A non-transitory computer-readable recording medium storing a bitstream of a video which is generated by a method performed by an apparatus for video processing, wherein the method comprises: determining a search range for intra template matching prediction (IntraTMP) for a video unit of the video; determining a prediction block of the video unit based on the search range; and generating the bitstream based on the prediction block.

Clause 166. A method for storing a bitstream of a video, comprising: determining a search range for intra template matching prediction (IntraTMP) for a video unit of the video; determining a prediction block of the video unit based on the search range; generating the bitstream based on the prediction block; and storing the bitstream in a non-transitory computer-readable recording medium.

### Example Device

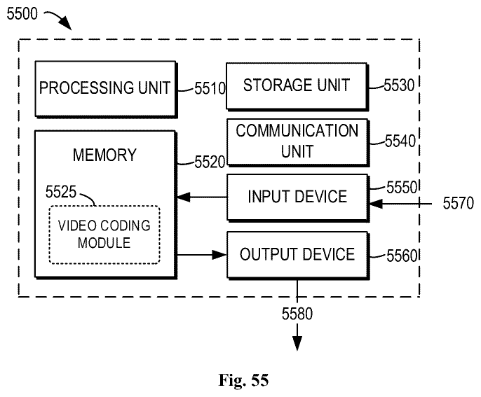

FIG. 55 illustrates a block diagram of a computing device 5500 in which various embodiments of the present disclosure can be implemented. The computing device 5500 may be implemented as or included in the source device 110 (or the video encoder 114 or 200) or the destination device 120 (or the video decoder 124 or 300).

It would be appreciated that the computing device 5500 shown in FIG. 55 is merely for purpose of illustration, without suggesting any limitation to the functions and scopes of the embodiments of the present disclosure in any manner.

As shown in FIG. 55, the computing device 5500 includes a general-purpose computing device 5500. The computing device 5500 may at least comprise one or more processors or processing units 5510, a memory 5520, a storage unit 5530, one or more communication units 5540, one or more input devices 5550, and one or more output devices 5560.

In some embodiments, the computing device 5500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 5500 can support any type of interface to a user (such as “wearable” circuitry and the like).

The processing unit 5510 may be a physical or virtual processor and can implement various processes based on programs stored in the memory 5520. In a multi-processor system, multiple processing units execute computer executable instructions in parallel so as to improve the parallel processing capability of the computing device 5500. The processing unit 5510 may also be referred to as a central processing unit (CPU), a microprocessor, a controller or a microcontroller.

The computing device 5500 typically includes various computer storage medium. Such medium can be any medium accessible by the computing device 5500, including, but not limited to, volatile and non-volatile medium, or detachable and non-detachable medium. The memory 5520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 5530 may be any detachable or non-detachable medium and may include a machine-readable medium such as a memory, flash memory drive, magnetic disk or another other media, which can be used for storing information and/or data and can be accessed in the computing device 5500.

The computing device 5500 may further include additional detachable/non-detachable, volatile/non-volatile memory medium. Although not shown in FIG. 55, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 5540 communicates with a further computing device via the communication medium. In addition, the functions of the components in the computing device 5500 can be implemented by a single computing cluster or multiple computing machines that can communicate via communication connections. Therefore, the computing device 5500 can operate in a networked environment using a logical connection with one or more other servers, networked personal computers (PCs) or further general network nodes.

The input device 5550 may be one or more of a variety of input devices, such as a mouse, keyboard, tracking ball, voice-input device, and the like. The output device 5560 may be one or more of a variety of output devices, such as a display, loudspeaker, printer, and the like. By means of the communication unit 5540, the computing device 5500 can further communicate with one or more external devices (not shown) such as the storage devices and display device, with one or more devices enabling the user to interact with the computing device 5500, or any devices (such as a network card, a modem and the like) enabling the computing device 5500 to communicate with one or more other computing devices, if required. Such communication can be performed via input/output (I/O) interfaces (not shown).

In some embodiments, instead of being integrated in a single device, some or all components of the computing device 5500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 5500 may be used to implement video encoding/decoding in embodiments of the present disclosure. The memory 5520 may include one or more video coding modules 5525 having one or more program instructions. These modules are accessible and executable by the processing unit 5510 to perform the functionalities of the various embodiments described herein.

In the example embodiments of performing video encoding, the input device 5550 may receive video data as an input 5570 to be encoded. The video data may be processed, for example, by the video coding module 5525, to generate an encoded bitstream. The encoded bitstream may be provided via the output device 5560 as an output 5580.

In the example embodiments of performing video decoding, the input device 5550 may receive an encoded bitstream as the input 5570. The encoded bitstream may be processed, for example, by the video coding module 5525, to generate decoded video data. The decoded video data may be provided via the output device 5560 as the output 5580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, for a conversion between a video unit of a video and a bitstream of the video, a search range for intra template matching prediction (IntraTMP) for the video unit;
determining a prediction block of the video unit based on the search range; and
performing the conversion based on the prediction block.

2. The method of claim 1, wherein an adaptive search range is used for IntraTMP, and/or
wherein the search range depends on a video content, and/or
wherein one or more syntax elements are signalled to indicate the determination of the search range, and/or
wherein the search range depends on coding information, and/or
wherein one or more search regions are used for IntraTMP.

3. The method of claim 1, wherein RW=(a1×BW+b1)>>s1 and/or RH=(a2×BH+b2)>>s2,
wherein RW represents a range width, RH represents a range height, BW represents a block width, BH represents a block height, a1, b1, s1 and a2, b2, s2 are integers.

4. The method of claim 1, wherein one or more thresholds are used for early termination in a searching process of IntraTMP.

5. The method of claim 4, wherein one or more thresholds are used to stop searching for IntraTMP, and/or
wherein the one or more thresholds are different for coarse searching and refinement searching, and/or
wherein the one or more thresholds depend on coding information.

6. The method of claim 5, wherein the coding information comprises at least one of: template size, template dimensions, block size, block dimensions, QP or a sum of absolute differences (SAD).

7. The method of claim 1, wherein a predictive searching is used for IntraTMP, wherein one or more starting points are used for searching, and/or
wherein one or more searching patterns is used for IntraTMP, and/or
wherein a plurality of templates is used for IntraTMP, and/or
wherein more than one candidate is generated for IntraTMP.

8. The method of claim 7, wherein a starting point list is constructed, and one or more of starting points in the starting point list are used for searching, and/or
wherein the one or more searching pattern are diamond, or square, or cross, or a variant of diamond, or a variant of square, or a variant of cross, and/or
wherein one or more templates including neighbouring reconstructed samples are used, and/or
wherein the more than one candidate is generated using different templates.

9. The method of claim 1, wherein one or more samples are generated to obtain a prediction signal for IntraTMP, if the one or more samples are not reconstructed.

10. The method of claim 9, wherein a padding method is used to generate the one or more samples.

11. The method of claim 10, wherein a repetitive padding or a mirror padding is used.

12. The method of claim 1, wherein one or more filtering method are used to process a prediction signal of the video unit for IntraTMP, and/or
wherein a fractional block vector is used for IntraTMP, and/or
wherein the fractional block vector is used for one or more video units.

13. The method of claim 12, wherein a precision of the fractional block vector is ½^{N}, wherein N is an integer larger than 0, and/or
wherein a plurality of precisions of fractional block vector is used, and/or
wherein a plurality of interpolation filters is used to generate prediction or reconstruction using the fractional block vector, and/or
wherein the fractional block vector is used to construct at least one of: an IBC advanced motion vector prediction (AMVP) candidate list, or an IBC merge candidate list, and/or
wherein the fractional block vector is rounded to integer block vector and used, and/or
wherein the fractional block vector is used to update a history based motion vector prediction (HMVP) table for IBC, and/or
wherein a rounded block vector of the fractional block vector is used, and/or
wherein the fractional block vector is not used to update the HMVP table for IBC, and/or
wherein the fractional block vector is used for other coding tool, and/or
wherein a block vector candidate list is constructed for IntraTMP, and/or
wherein a HMVP table is used for IntraTMP, and the fractional block vector is stored in the HMVP table for IntraTMP, and/or
wherein a fractional block vector of luma component is used for chroma component, and/or
wherein one or more block vectors at different positions of luma video units are used, and/or
wherein if the fractional block vector is used to derive an intra prediction mode, the fractional block vector is rounded to an integer block vector.

14. The method of claim 13, wherein N=1, or 2, or 3, or, 4, or 5, or 6, and/or
wherein the fractional block vector is directly used, if the fractional block vector is used for IBC or IntraTMP, and/or
wherein the other coding tool comprises IntraTMP, and/or
wherein the fractional block vector is used to construct the block vector candidate list.

15. The method of claim 1, wherein one or more offsets are used to modify a block vector for IntraTMP, and/or
wherein IntraTMP is used to generate a prediction or reconstruction of at least one subblock, if the video unit is divided into a plurality of subblocks.

16. The method of claim 15, wherein the plurality of subblocks is rectangular or square.

17. The method of claim 1, wherein the conversion includes encoding the video unit into the bitstream, or
wherein the conversion includes decoding the video unit from the bitstream.

18. An apparatus for video processing comprising a processor and a non-transitory memory with instructions thereon, wherein the instructions upon execution by the processor, cause the processor to perform a method comprising:
determining, for a conversion between a video unit of a video and a bitstream of the video, a search range for intra template matching prediction (IntraTMP) for the video unit;
determining a prediction block of the video unit based on the search range; and
performing the conversion based on the prediction block.

19. A non-transitory computer-readable storage medium storing instructions that cause a processor to perform a method comprising:
determining, for a conversion between a video unit of a video and a bitstream of the video, a search range for intra template matching prediction (IntraTMP) for the video unit;
determining a prediction block of the video unit based on the search range; and
performing the conversion based on the prediction block.

20. A non-transitory computer-readable recording medium storing a bitstream of a video which is generated by a method performed by an apparatus for video processing, wherein the method comprises:
determining a search range for intra template matching prediction (IntraTMP) for a video unit of the video;
determining a prediction block of the video unit based on the search range; and
generating the bitstream based on the prediction block.
